(19) United States
(12) Patent Application Publication
(10) Pub. No.: US 2026/0057557 A1
(43) Pub. Date: Feb. 26, 2026

(54) METHOD FOR ENCODING AND DECODING A 3D POINT CLOUD, ENCODER, DECODER

(71) Applicant: Beijing Xiaomi Mobile Software Co., Ltd., Beijing (CN)

(72) Inventor: Shuo GAO, Beijing (CN)

(21) Appl. No.: 19/102,605

(22) PCT Filed: Aug. 11, 2022
(86) PCT No.: PCT/CN2022/111930

§ 371 Date: Feb. 10, 2025

(51) Int. Cl. G06T 9/00; G06T 9/40

(52) U.S. Cl. CPC G06T 9/001; G06T 9/40

(57) ABSTRACT

A method for encoding a 3D point cloud into a bitstream is implemented in an encoder, a geometry of the point cloud being defined in an octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure. The method includes: obtaining nodes encompassing at least part of the point cloud at a depth d in a lexicographic order along each axis of the coordinate system; determining a neighbour pattern for each node Nₖ based on a subset of neighbour nodes; and entropy encoding the occupancy information of each node into a bitstream based on the neighbour pattern.

### CROSS-REFERENCE TO RELATED APPLICATION

The present application is the US National Stage of International Application No. PCT/CN2022/111930, filed on Aug. 11, 2022, the entire disclosure of which is incorporated herein by reference.

### TECHNICAL FIELD

The present disclosure relates to a method for encoding a 3D point cloud into a bitstream. Additionally, it is an object of the present disclosure to provide a method for decoding a 3D point cloud from a bitstream. Further, it is an object of the present disclosure to provide an encoder and decoder, a bitstream encoded according to the present disclosure and a software. In particular, it is an object of the present disclosure to provide a method for retrieving neighbouring nodes and/or neighbouring child nodes occupancy while coding or decoding the occupancy tree without sacrificing memory and complexity of algorithm.

### BACKGROUND

As a format for the representation of 3D data, point clouds have recently gained traction as they are versatile in their capability in representing all types of 3D objects or scenes. Therefore, many use cases can be addressed by point clouds, among which are
movie post-production,
real-time 3D immersive telepresence or VR/AR applications,
free viewpoint video (for instance for sports viewing),
Geographical Information Systems (aka cartography),
culture heritage (storage of scans of rare objects into a digital form),
Autonomous driving, including 3D mapping of the environment and real-time Lidar data acquisition

A point cloud is a set of points located in a 3D space, optionally with additional values attached to each of the points. These additional values are usually called point attributes. Consequently, a point cloud is combination of a geometry (the 3D position of each point) and attributes.

Attributes may be, for example, three-component colours, material properties like reflectance and/or two-component normal vectors to a surface associated with the point.

Point clouds may be captured by various types of devices like an array of cameras, depth sensors, Lidars, scanners, or may be computer-generated (in movie post-production for example). Depending on the use cases, points clouds may have from thousands to up to billions of points for cartography applications.

Raw representations of point clouds require a very high number of bits per point, with at least a dozen of bits per spatial component X, Y or Z, and optionally more bits for the attribute(s), for instance three times 10 bits for the colours. Practical deployment of point-cloud-based applications requires compression technologies that enable the storage and distribution of point clouds with reasonable storage and transmission infrastructures.

Compression may be lossy (like in video compression) for the distribution to and visualization by an end-user, for example on AR/VR glasses or any other 3D-capable device. Other use cases do require lossless compression, like medical applications or autonomous driving, to avoid altering the results of a decision obtained from the analysis of the compressed and transmitted point cloud.

Until recently, point cloud compression (aka PCC) was not addressed by the mass market and no standardized point cloud codec was available. In 2017, the standardization working group ISO/JCT1/SC29/WG11, also known as Moving Picture Experts Group or MPEG, has initiated work items on point cloud compression. This has led to two standards, namely d
MPEG-I part 5 (ISO/IEC 23090-5) or Video-based Point Cloud Compression (V-PCC) and
MPEG-I part 9 (ISO/IEC 23090-9) or Geometry-based Point Cloud Compression (G-PCC).

Both V-PCC and G-PCC standards have finalized their first version in late 2020 and will soon be available to the market.

The V-PCC coding method compresses a point cloud by performing multiple projections of a 3D object to obtain 2D patches that are packed into an image (or a video when dealing with moving point clouds). Obtained images or videos are then compressed using already existing image/video codecs, al-lowing for the leverage of already deployed image and video solutions. By its very nature, V-PCC is efficient only on dense and continuous point clouds because image/video codecs are unable to compress non-smooth patches as would be obtained from the projection of, for example, Lidar-acquired sparse geometry data.

The G-PCC coding method has two schemes for the compression of the geometry.

The first scheme is based on an occupancy tree (octree/quadtree/binary tree) representation of the point cloud geometry. Occupied nodes are split down until a certain size is reached, and occupied leaf nodes provide the location of points, typically at the centre of these nodes. By using neighbour-based prediction techniques, high level of compression can be obtained for dense point clouds. Sparse point clouds are also addressed by directly coding the position of point within a node with non-minimal size, by stopping the tree construction when only isolated points are present in a node; this technique is known as Direct Coding Mode (DCM).

The second scheme is based on a predictive tree, each node representing the 3D location of one point and the relation between nodes is spatial prediction from parent to children. This method can only address sparse point clouds and offers the advantage of lower latency and simpler decoding than the occupancy tree. However, compression performance is only marginally better, and the encoding is complex, relatively to the first occupancy-based method, intensively looking for the best predictor (among a long list of potential predictors) when constructing the predictive tree.

In both schemes, attribute (de) coding is performed after complete geometry (de) coding, leading to a two-pass coding. Thus, low latency is obtained by using slices that decompose the 3D space into sub-volumes that are coded independently, without prediction between the sub-volumes. This may heavily impact the compression performance when many slices are used.

An important use case is the transmission of dynamic AR/VR point clouds. Dynamic means that the point cloud evolves with respect to time. Also, AR/VR point clouds are typically locally 2D as they most of time represent the surface of an object. As such, AR/VR point clouds are highly connected (or said to be dense) in the sense that a point is rarely isolated and, instead, has many neighbours.

### SUMMARY

In a first aspect, a method for encoding a 3D point cloud into a bitstream, preferably implemented in an encoder is provided. A geometry of the point cloud being defined in an octree structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein an occupancy information associated with each respective child sub-volume indicates whether that respective child sub-volume contains at least one of the points, the method comprising:
Obtaining nodes encompassing at least part of the point cloud at depth d in a lexicographic order along each of the axes X, Y, Z of the coordinate system;
Determining a neighbour pattern for each node Nₖ based on a subset of neighbour nodes;
Entropy encoding the occupancy information of each node into a bitstream based on the neighbour pattern.

A point cloud is a set of points in a three-dimensional coordinate system. The points are often intended to represent the external surface of one or more objects. Each point has a location (position) in the three-dimensional coordinate system. The position may be represented by three coordinates (X, Y, Z), which can be Cartesian or any other coordinate system. Thus, according to the present disclosure, for a given depth d in the octree, the nodes are obtained in a lexicographic order. With the lexicographic ordering (whatever is the axis ordering used in lexicographic order), the occupancy of any nodes with a lower z, a lower y or a lower x position may be used for contextualization. Preferably, the nodes are stored in a linked data structure (for instance a linked list). Therein, the linked data structure has elements connected to each other so that elements are arranged in a sequential manner. Preferably, a list L_{d} can be used to store the nodes and the nodes can be obtained iteratively from the list. Moreover, the neighbour pattern for each node is determined based on a subset of neighbours. According to the technical solution of the present disclosure, with lexicographic ordering of the nodes and only a subset of neighbour nodes is considered in the determination of neighbour pattern, it is possible to avoid wasting too much memory with an occupancy atlas.

It shall be understood that all the technical solution described therebefore with respect to the tracking of neighbouring nodes and/or using raster scan order also apply to the entropy encoding and/or decoding of the child nodes.

In another aspect of the present disclosure, a method for decoding a 3D point cloud into a bitstream, preferably implemented in a decoder is provided. A geometry of the point cloud being defined in an octree structure having a plurality of nodes having parent-child relationships and rep-resenting a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein an occupancy information associated with each respective child sub-volume indicates whether that respective child sub-volume contains at least one of the points, the method comprising:
Obtaining nodes encompassing at least part of the point cloud at depth d in a lexicographic order along each of the axes X, Y, Z of the coordinate system;
Determining neighbour pattern for each node Nₖ based on a subset of neighbour nodes;
Entropy decoding the occupancy information of each node from a bitstream based on the neighbour pattern.

In another aspect of the present disclosure an encoder is provided for encoding a 3D point cloud into a bitstream. The encoder comprises a memory and a processor, wherein instructions are stored in the memory, which when executed by the processor perform the steps of the method for encoding described before.

In another aspect of the present disclosure a decoder is provided for decoding a 3D point cloud from a bitstream. The decoder comprises a memory and a processor, wherein instructions are stored in the memory, which when executed by the processor perform the steps of the method for decoding de-scribed before.

In another aspect of the present disclosure a bitstream is provided, wherein the bitstream is encoded by the steps of the method for encoding described before.

In another aspect of the present disclosure a computer-readable storage medium is provided comprising instructions to perform the steps of the method for encoding a 3D point cloud into a bitstream as described above.

In another aspect of the present disclosure a non-transitory computer-readable storage medium is provided comprising instructions to perform the steps of the method for decoding a 3D point cloud from a bitstream as described above.

### BRIEF DESCRIPTION OF THE DRAWINGS

In the following the present disclosure is described in more detail with reference to the accompanying figures.

FIG. 1 shows an example of occupied nodes/voxels in a neighbourhood, according to an embodiment.

FIG. 2 shows a neighborhood made of nodes at same and higher depth than the current node, according to an embodiment.

FIG. 3 shows an example of occupied nodes in a neighborhood involving higher than current depth neighbors, according to an embodiment.

FIG. 4 shows an occupancy map (white cubes) known from previously encoded or decoded occupancy bits when encoding or decoding occupancy bit of a child node (striped cube) using a Morton order, according to an embodiment.

FIG. 5 shows raster scan processing of parent nodes for raster scan coding of the occupancy of their child nodes, according to an embodiment.

FIG. 6 shows coding order of slice 0 and slice 1 of occupied nodes of same fixed x at current depth, according to an embodiment.

FIG. 7 shows one example of a decoder, according to an embodiment.

FIG. 8 shows one example of an encoder, according to an embodiment.

FIG. 9 shows an occupancy map (white cubes) known from previously encoded occupancy bits when encoding occupancy bit of a child node (striped cube) using a raster scan order, according to an embodiment.

FIG. 10 shows raster scan ordered parents nodes with 8 child occupancy bits coding and raster scan ordering of the child nodes, according to an embodiment.

FIG. 11 shows an example of another decoder (decoding method using raster scan ordered parents nodes with 8 child occupancy bits coding together), according to an embodiment.

FIG. 12 shows an example of another encoder (encoding method using raster scan ordered parents nodes with 8 child occupancy bits coding together), according to an embodiment.

FIG. 13 shows an occupancy map (white cubes) known from previously encoded or decoded occupancy bits when encoding or decoding occupancy bit of a child node (striped cube) using a raster scan order of the nodes but coding all the bits for the child nodes' occupancy using a Morton order, according to an embodiment.

FIG. 14 shows an overview of a decoding method by using the proposed method, according to an embodiment.

FIG. 15 shows an overview of an encoding method by using the proposed method, according to an embodiment.

FIG. 16 shows 26 neighbour nodes of current node (central node) being coded, according to an embodiment.

FIGS. 17a and 17b show flowcharts of process to determine occupancy of neighbour nodes for a node, according to an embodiment.

FIG. 18 shows a detail process to determine childOccupancy of 13 neighbour nodes of node Nₖ, according to an embodiment.

FIG. 19 shows a detail process to determine depthOccupancy of 13 neighbour nodes of node Nₖ, according to an embodiment.

FIG. 20 shows a detail process to determine childOccupancy of two neighbour nodes in the same tube as NeighP[i], according to an embodiment.

FIG. 21 shows a detail process to determine depthOccupancy of two neighbour nodes in the same tube as NeighP[i], according to an embodiment.

FIG. 22 shows neighbour child nodes to be retrieved of current child node, wherein each cube represents a child node, according to an embodiment.

FIG. 23 shows a schematic flow diagram of the method for encoding, according to an embodiment.

FIG. 24 shows a schematic flow diagram of the method for decoding, according to an embodiment.

FIG. 25 shows an encoder according to an embodiment.

FIG. 26 shows a decoder according to an embodiment.

### DETAILED DESCRIPTION OF THE EMBODIMENTS

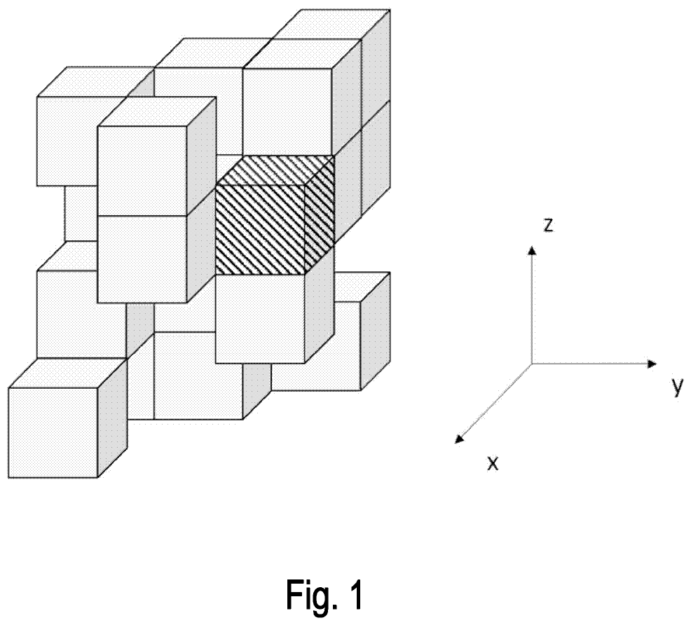

FIG. 1 depicts an example of neighbourhood for which only occupied nodes/voxels have been drawn. The number of possible occupancy configuration of the neighbourhood is 2N where N is the number of nodes/voxels involved in the neighbourhood.

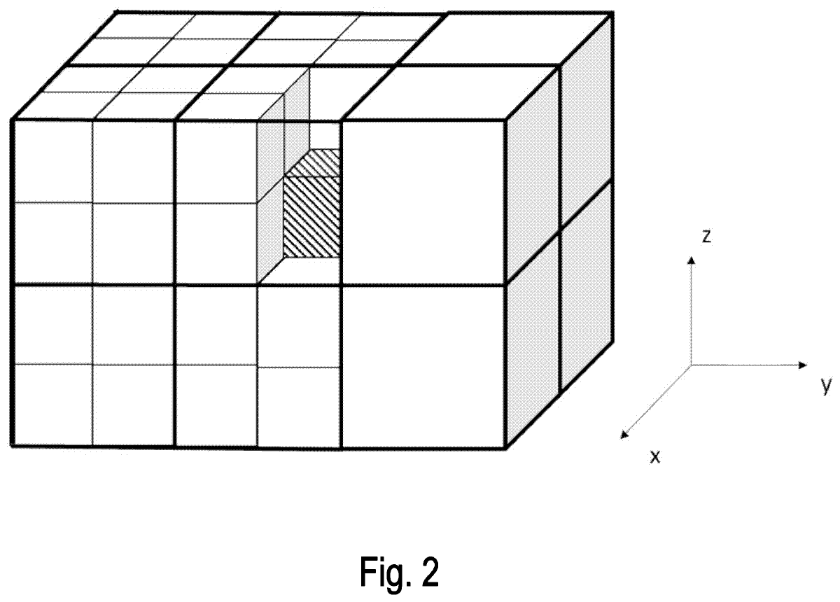

In an octree representation of the point cloud, if nodes are processed in a depth first order as in MPEG GPCC, one may profit from the knowledge of the occupancy of nodes at higher depth as explained on FIG. 2.

Nodes at depth higher than the current node are used to obtain geometry information in regions (here for y higher than the y of the current node) not yet coded at current depth.

In MPEG G-PCC, a combination of neighbouring nodes at current depth and current depth plus one are used to define a neighbourhood. However, in order to limit the number of possible neighbourhood configurations, the neighbourhood has been limited to a subset of the set of nodes adjacent to the current node.

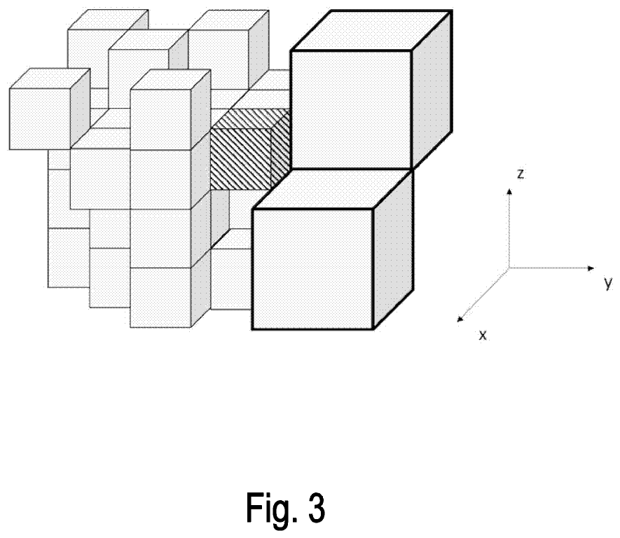

FIG. 3 depicts an example of neighbourhood, for which only occupied nodes have been drawn, when neighbouring nodes of depth higher than the current depth are also involved.

By construction, Morton ordering also allows easily considering neighbourhood in a given cubic sub-volume, the cubic sub-volume containing all the nodes, at a first given depth Do, with Morton codes sharing a common prefix (when written in binary format). This prefix corresponds to the Morton code of the common ancestor node at a second given depth D₁ whose total volume is the same as the given cubic sub-volume. The size of the sub-volume in number of possible Morton codes (i.e., nodes) at a given depth is then 2^{N}, where N is the number of bits lower than the Morton code prefix. N would then correspond to three times the first given depth minus the second given depth: N=3×(D₀−D₁). In current G-PCC method, the occupancy of such neighbourhood may for instance be buffered in linear memory space containing the occupancy of all the possible Morton codes in the 3D volume. This representation of the occupancy is sometimes called the occupancy atlas in G-PCC. The occupancy of a child node at a given child position in the volume can thus be retrieved directly from its position in the buffer, corresponding to the Morton suffix (made of the N bits) of the child node.

It allows to find quickly/immediately (i.e. complexity is in O(1)) a given neighbour's occupancy inside of this volume. The overall complexity of looking for neighbouring nodes occupancy for coding the children occupancy of N nodes would then be in O(N) but the coding efficiency would be suboptimal, being limited by the atlas size (neighbours outside of the cube/volume represented by the atlas cannot be obtained, and it penalizes coding efficiency).

Instead of using the occupancy atlas, to avoid consuming that memory but having the same behaviour as G-PCC on the boundaries of the atlas, one could search for neighbouring nodes' occupancy inside of a data structure, limiting the search to the nodes contained inside of the same volume as the one considered by the atlas. For instance, the search for a given neighboring node inside of the buffer containing all the ordered occupied node could have a logarithmic cost of the number of nodes inside of the same volume.

Occupancy map and search methods can be applied to get the occupancy of neighbour nodes at same tree depth as well as the occupancy of previously coded neighbour child nodes for next tree depth. In case of occupancy map, one could use one occupancy map/atlas for nodes at same tree depth and one occupancy map/atlas for nodes at next depth or store them together. In the case of search method, the occupancy of child nodes for next tree depth may be stored in a memory structure associated with the nodes at same tree depth, in order to reduce a bit the search complexity.

Outside of G-PCC, if the occupancy atlas size is not constrained at all (and so, there is never occupied neighbours missing since there is no atlas boundaries), one could prefer not using atlas at all because it could potentially become too big in memory, but then neighbouring search complexity would be increased.

If the neighbours' search is made in a Morton ordered list/buffer of nodes the overall complexity of looking for neighbouring nodes to determine the contexts for coding the children occupancy of N nodes would be in O(N·log₂(N)). One could try to reduce this complexity by using a hash table but this is at the cost of an increased memory usage (in comparison to the list/buffer of occupied nodes); and, in the verry best case (if using sufficient memory and a suited hashing function) the complexity would become O(N), but in the very worst case the complexity could fall in O(N²) (or O(N·log₂(N)) depending on hash collision handling). Furthermore, one would need to build/populate the hash table before being able to use it.

The occupancy atlas thus reduces complexity, but this is at the cost of increased memory use. Typically for a good compromise in coding efficiency the atlas size is several megabytes of data.

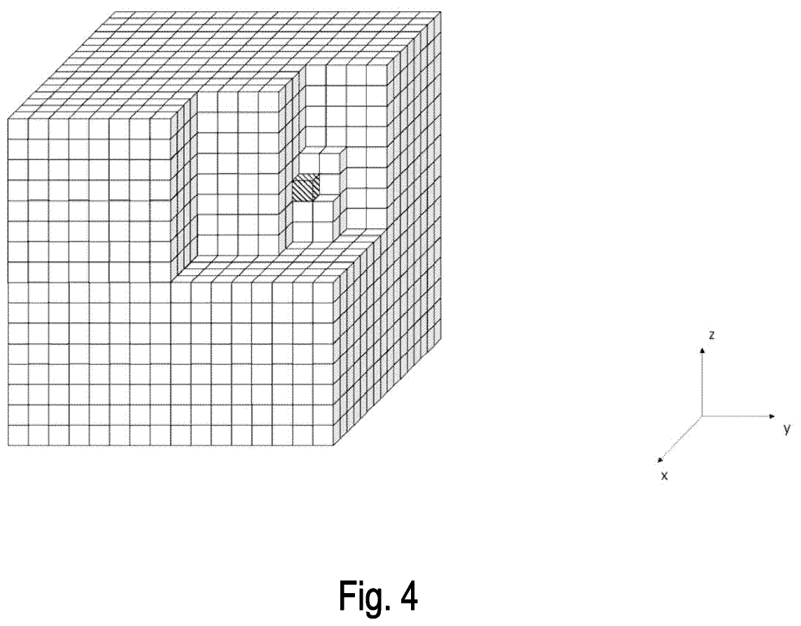

FIG. 4 shows the volume (made of white cubes) in which the occupancy at a given depth is known when performing the coding of an occupancy bit for a current child node (striped cube) in case nodes are processed in Morton order and occupancy bits are also coded in Morton order.

From this figure it may be also understood the nature of the different sub-volumes that could be mapped within an occupancy atlas.

According to some methods, the child volume occupancy bits are encoded/decoded based on nodes in raster scan order at a given depth in the occupancy tree. Some uses raster scan order of the child volumes to code/decode their respective occupancy bits. Some uses the raster scan order of the nodes to code/decode the occupancy bits of all their respective child volumes (together) to get more optimal coding efficiency.

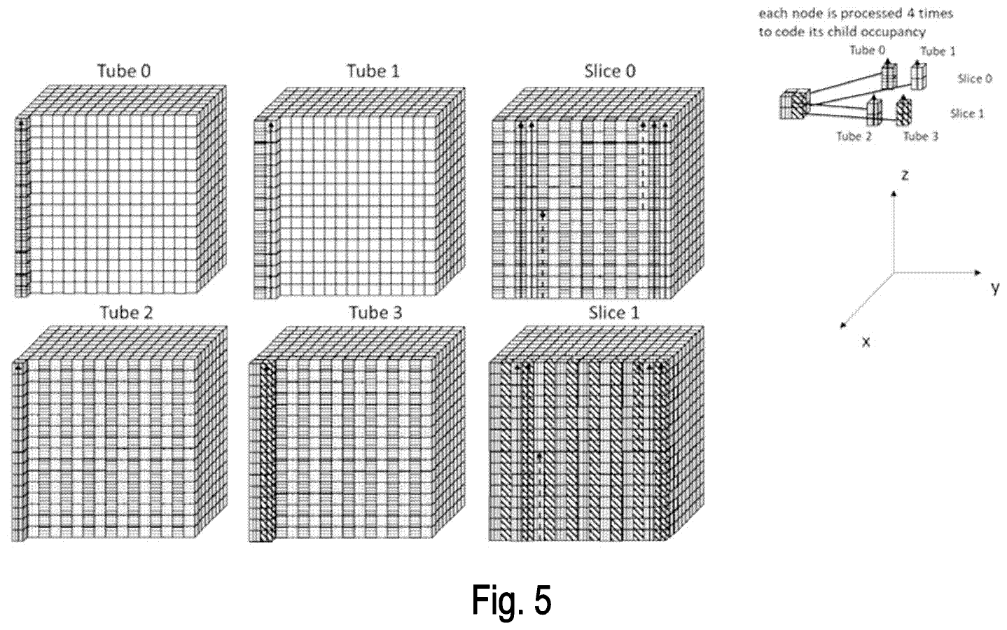

One example of the above-described method is illustrated in FIG. 5 (example 1). For a better understanding, the full occupancy volume is represented in the figure, to better see the raster scan order of the processing. But one should understand that some part of the volume will not be coded/processed if ancestors' nodes have been indicated as unoccupied.

As shown in FIG. 5, a lexicographic order in (x, y, z) (i.e. a colexicographic order in (z, y, x)) is used. For a given depth in the octree, the child nodes' occupancy is coded following the raster scan order of the child nodes. To achieve raster scan order of child nodes, 4 tubes (tube 0, tube 1, tube 2, tube 3) for each node at current depth are defined, each tube being made from every node with a same x and y. And coding the occupancy bits of child nodes of tube 0 is performed by coding the occupancy bits b0 then b1 of all the occupied nodes with same fixed x and y, and the nodes being ordered by increasing z of all the occupied nodes. The coding of the occupancy tube 1 is then performed, by coding the occupancy bits b2 then b3 of the same nodes, and in the same order as for tube 0.

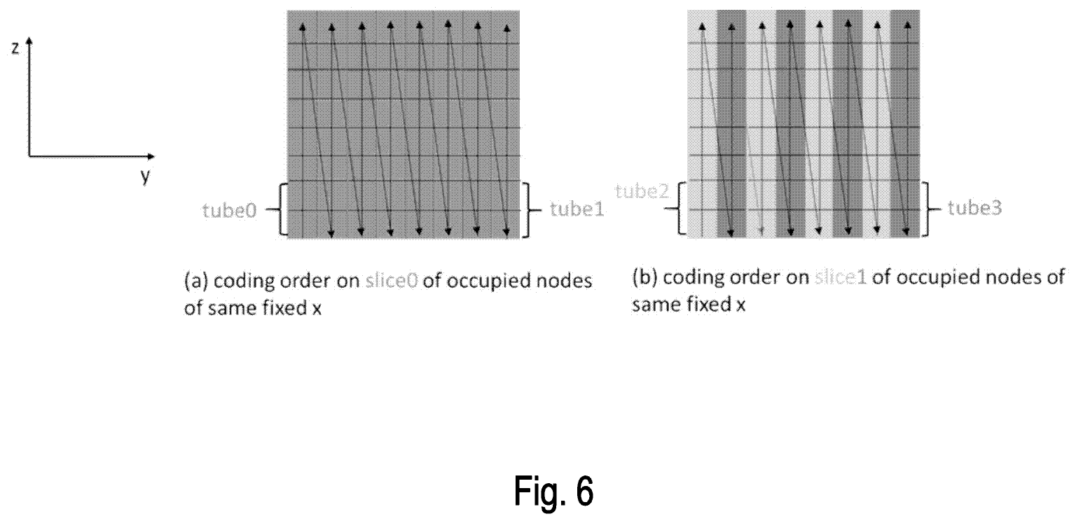

The coding process for coding occupancy tube 0 of all the occupied nodes with same fixed x and y and occupancy tube 1 of all the occupied nodes with same fixed x and y is repeated for every y, in increasing y order. It provides a raster scan coding of the slice 0 made of every bit b0, b1 b2, b3 of all the occupied nodes with same x. The illustration of raster scan order of slice0 of these nodes is shown in FIG. 6(a), wherein each child node is represented in 2D to better illustrating. After coding the slice0 of the nodes at a fixed x, then it codes the slice1 of these nodes at same x and the coding process of slice 0 is reproduced for slice 1, by successively coding in the same order, the occupancy tubes 2 then 3 made of occupancy bits b4 and b5 then b6, b7 of the same nodes. And the coding process of the illustration of raster scan order of slice 1 of these nodes is shown in FIG. 6(b) wherein each child nodes are represented in 2D to better illustrating. The coding process of slice 0 then slice 1, is repeated for every x of nodes at current depth, in increasing order, of all the occupied nodes.

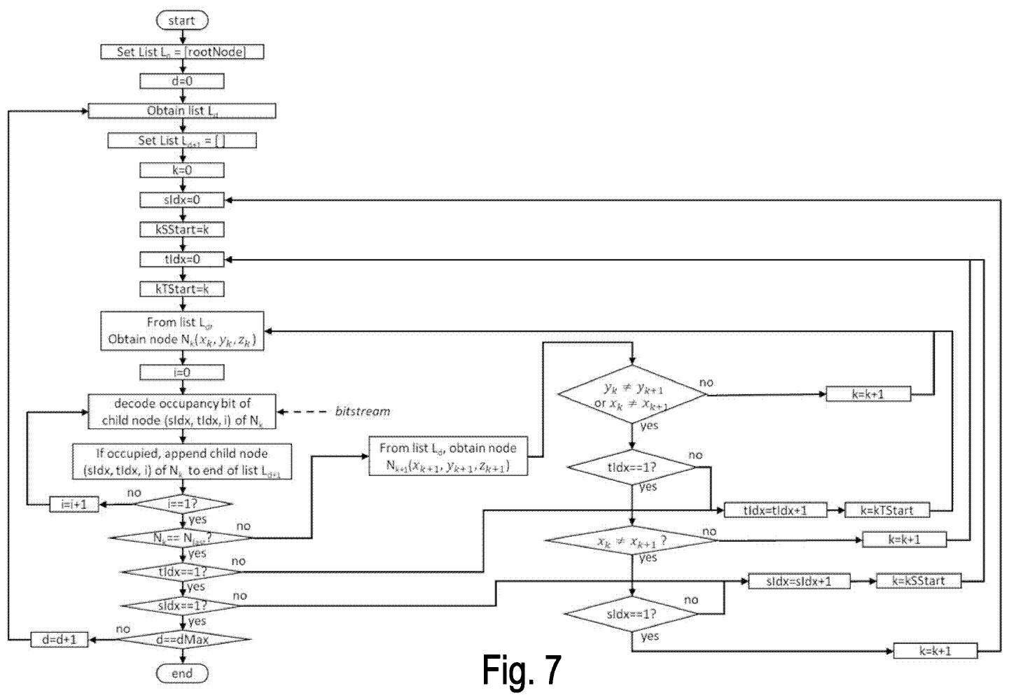

One example of the decoder (the corresponding decoder of example 1) with above mentioned method is shown in FIG. 7 as a block diagram, wherein a list L_{d} represents a list containing nodes Nₖ(xₖ, yₖ, zₖ) at a depth d in the octree, the nodes being ordered in raster scan order from N₀ to Nₗₐₛₜ, and k being the order index of the node in the list L_{d}. The FIG. 7 shows both
the process to decode occupancy of the child nodes (sIdx, tIdx, i) at depth d+1 from bitstream following raster scan order
and the process to put child nodes into list L_{d+1} to generate raster scan ordered nodes for next depth.

The variable sIdx represents the index of a slice of all the occupied nodes with a same x; the variable tIdx represents the index of a tube of all the occupied nodes with a same x and y; and the variable i represents the index of a child within each tube.

In other words, the integer value obtained from the binary word formed by (sIdx, tIdx, i) is the child index of a node (a decimal value from 0 to 7). The variable kSStart is used to store the order index of the first node of a slice of all the occupied nodes with a same x; and the variable kTStart is used to store the order index of the first node of a tube of all the occupied nodes with a same x and y. The depth dMax is the maximum depth in the tree and can be determined from the bitstream.

The detailed process in decoder can be described as below:
To Initialize the algorithm, by set the list L₀ to contain only the root node of the occupancy tree, and set the initial depth d to 0.
Label0
Obtain a (fifo) list L_{d} which stores nodes at depth d in raster scan order
Obtain an empty list L_{d+1} to produce raster scan ordered child nodes used for decoding of next depth;
Set node index k as 0 (initialize variable k with value 0)
Label1:
Set slice index sIdx as 0 (initialize variable sIdx with value 0)
Set first node index in the slice as k (initialize variable kSStart with value of k)
Label2:
Set tube index tIdx as 0 (initialize variable tIdx with value 0)
Set first node index in the tube as k (initialize variable kTStart with value of k)
Label3:
Obtain node Nₖ(xₖ, yₖ, zₖ) from list L_{d};
Set child index in the tube as 0 (Initialize variable i with value 0)
process0: decode and generate ordered child nodes for the child nodes in tube tIdx of slice sIdx of the node Nₖ in L_{d}.
   decode occupancy bit of the i-th child of tube tIdx of slice sIdx (which is child node (sIdx, tIdx, i) of Nₖ) from bitstream.
   If the decoded bit indicate that the child is occupied, append a new node for the i-th child of tube tIdx of slice sIdx (which is child node (sIdx, tIdx, i) of Nₖ) at end of list L_{d+1}. This new node has coordinates (2×xₖ+sIdx, 2×yₖ+tIdx, 2×zₖ+i).
   If i is not equal to 1, increase i and repeat the process0, else got to next step
Judge if Nₖ is last node of depth d (i.e. last node of list L_{d}):
   If Nₖ is not last node of depth d, obtain next occupied node Nₖ₊₁(xₖ₊₁, yₖ₊₁, zₖ₊₁) from list L_{d}. Then judge if xₖ≠xₖ₊₁ or yₖ≠yₖ₊₁
      If xₖ≠xₖ₊₁ or yₖ≠yₖ₊₁, it means the next node does not belong to the same tube of occupied nodes having same x and same y. (Then judge if tIdx==1
         If tIdx==1 it means the processing of the two tubes of child nodes (in a tube of all occupied nodes with a same x and y) of the current slice of child nodes has been finished. Then judge if xₖ≠xₖ₊₁
         If xₖ≠xₖ₊₁ it means the next node does not belong to the same slice of occupied nodes having same x. Then judge if sIdx==1
         If sIdx==1 it means the processing of the two slices of child nodes (in a slice of all occupied nodes with a same x) has been finished. Nₖ₊₁ is thus the starting point of the next slice of occupied nodes, and of next tube of occupied nodes to be processed.
         Increase k by one and loop to Label1 to start processing the first tube of child nodes of the first slice of child nodes of the next slice of occupied nodes.
         Otherwise sIdx==0. It means we can start processing the second slice of occupied nodes.
         Label4:
         Increase slice index sIdx by 1 and reset k to the index of the first node of the slice of all the occupied nodes with a same x: k=kSStart.
         Loop to Label 2 to start processing the third tube of child nodes.
         Otherwise xₖ==xₖ₊₁. it means the next node belongs to the same slice of occupied nodes, but to next tube of occupied nodes. Nₖ₊₁ is thus the starting point of the next tube to be processed.
         Increase k by one and loop to Label2 to start processing the first tube of child nodes (belonging to the current slice sIdx of child nodes) of the next tube of occupied nodes.
         Otherwise tIdx==0. It means we can start processing the second tube of child nodes of the current slice of child nodes.
         Label5:
         Increase tube index tIdx by 1 and reset k to the index of the first node of the tube of all the occupied nodes with a same x and y: k=kTStart.
         Loop to Label 3 to start processing the second tube of child nodes.
      Otherwise xₖ==xₖ₊₁ and yₖ==yₖ₊₁. It means the next node belongs to the same tube of occupied nodes. Increase k by one and loop to Label3 to continue processing the same tube of child nodes.
   Otherwise Nₖ==Nₗₐₛₜ, the node is the last node at depth d. Then judge if tIdx==1.
      If tIdx==1 it means the processing of the last tube of child nodes of the current slice of child nodes has been finished. And next slice of child nodes (if remaining) may to be processed. Then judge if tIdx==1.
         If sIdx==1 it means the processing of the last slice of child nodes of the last slice of occupied nodes has been finished. And next depth in the occupancy tree (if remaining) may to be processed. Then judge if d==dMax.
         If d==dMax, it means the last depth of the occupancy tree has been decoded. The occupancy tree is then completed.
         Otherwise, d<dMax. It means the next depth of the occupancy tree can be processed. Increase depth d by one and loop to Label0 to process next depth in the occupancy tree.
         Otherwise sIdx==0. It means the processing of the second slice of child nodes of the last slice of occupied nodes may be started. Go to label4 to start it.
      Otherwise tIdx==0. It means the processing of the last tube of child nodes of the current slice of child nodes may be started. Go to label5 to start it.

The List L_{d+1} can be omitted, and the child nodes are not appended to that list when d==dMax, because the list will not be used since no more depth will be processed.

The coordinates of a child node are the coordinates of its parent nodes refined by one bit of precision. In other words some physical spatial coordinates of the center of a node could be obtained by multiplying the coordinates of the center of the node by the physical dimensions of the node's volume scaled according to the depth:

$$( ( {x}_{k} , {y}_{k} , {z}_{k} ) + ( 0.5 , 0.5 , 0.5 ) ) \times ( width , length , height ) / {2}^{depth} .$$

Preferably, when d==dMax, if child nodes are occupied, points with coordinates ((2×xₖ+sIdx, 2×yₖ+tIdx, 2×zₖ+i)+(0.5, 0.5, 0.5))×(width, length, height)/2^{dMax} are output (for instance in a buffer). It produces raster scan ordered points geometry.

From the above coding process of child nodes, it is observed that each node Nₖ needs to be accessed/processed 4 times: the first time it is accessed/processed is for coding the occupancy tube 0, the second time is for coding the occupancy tube 1, the third time is for coding the occupancy tube 2 and the last time is for coding the occupancy tube 3.

The mentioned orderings of the nodes N_{k¬} that are needed by this coding process to build a raster scan ordering of the child nodes occupancy are al-ready obtained from the raster scan ordering of the processed nodes. And the raster scan ordering of the nodes is directly obtained from the raster scan ordering of the child nodes occupancy coding made for parent nodes (i.e. during the previous depth of the octree occupancy coding).

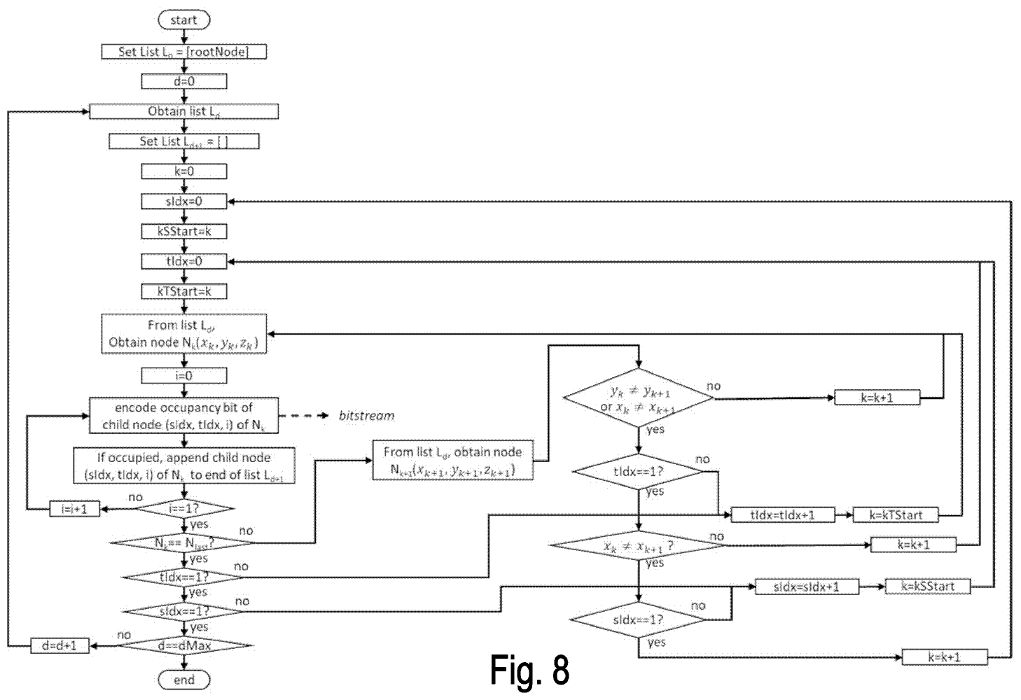

The encoder of example 1 is shown in FIG. 8 as a block diagram.

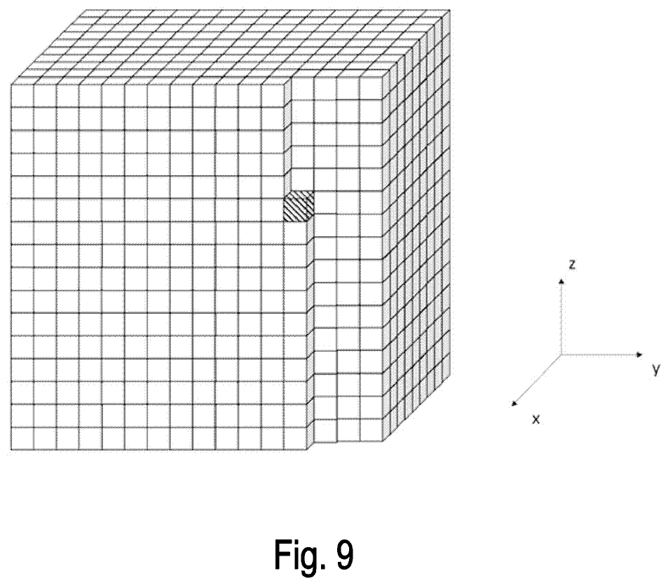

The effect of the proposed method is shown in FIG. 9, which shows the occupancy map coverage of child volumes already known when coding the occupancy bit for the striped child volume, when the occupancy bits are coded following raster scan order of the child volumes of the nodes. FIG. 9 also permits to see the neighbouring positions that can be used to build contexts for entropy coding of the occupancy bit. With the raster scan ordering (whatever is the axis ordering used in lexicographic order), the occupancy of any child volume with a lower z, a lower y or a lower x position may be used for contextualization. A predetermined pattern of neighbouring child volumes may thus be defined and can be used to select coding context for any coded occupancy bit.

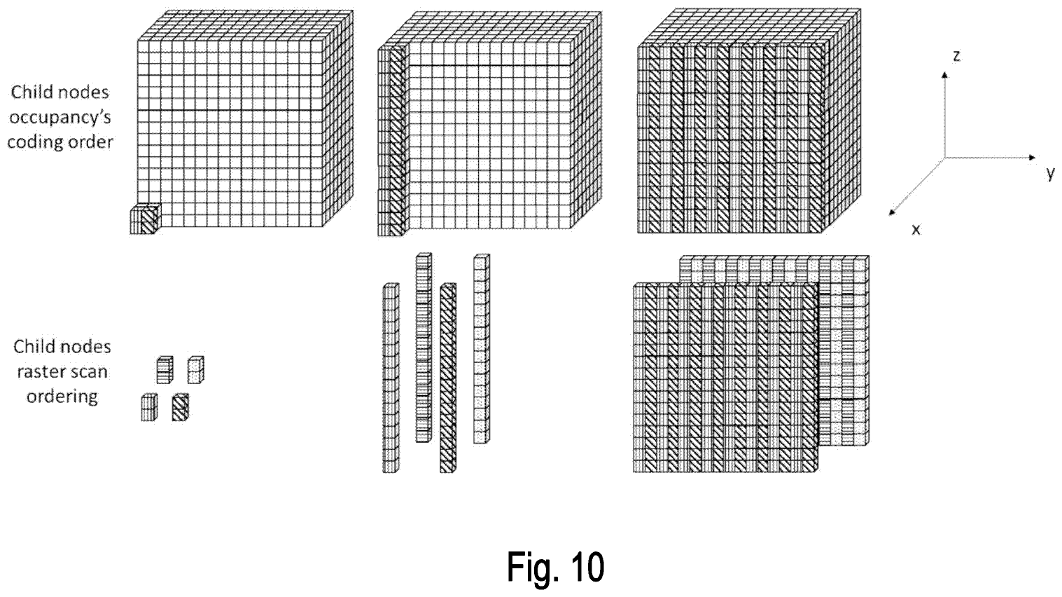

According to other examples, the method uses the raster scan order of the nodes to code/decode the occupancy bits of all their respective child volumes (together) at a given depth in the occupancy tree. In this example, as illustrated in FIG. 10, occupied nodes are processed in raster scan order, but the occupancy bits for all the child volumes of the nodes are successively coded by an order in a single pass on the node, for instance using Morton scan ordering of the child nodes occupancy bits (it means code the child volumes of each node using Morton order in a single pass on the node); and to order the child nodes by raster scan order for next depth, it uses child nodes ordering method same as that in the first example, which uses 4 passes on each node at current depth and is shown in FIG. 7.

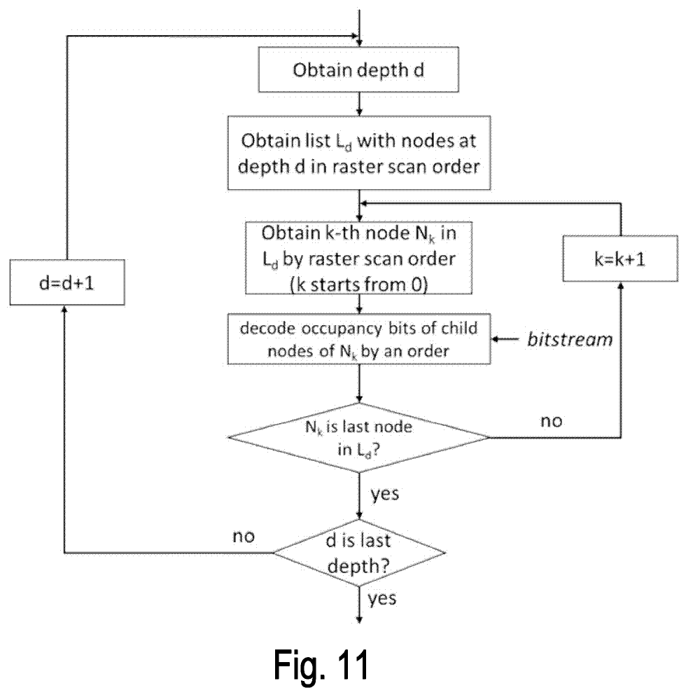

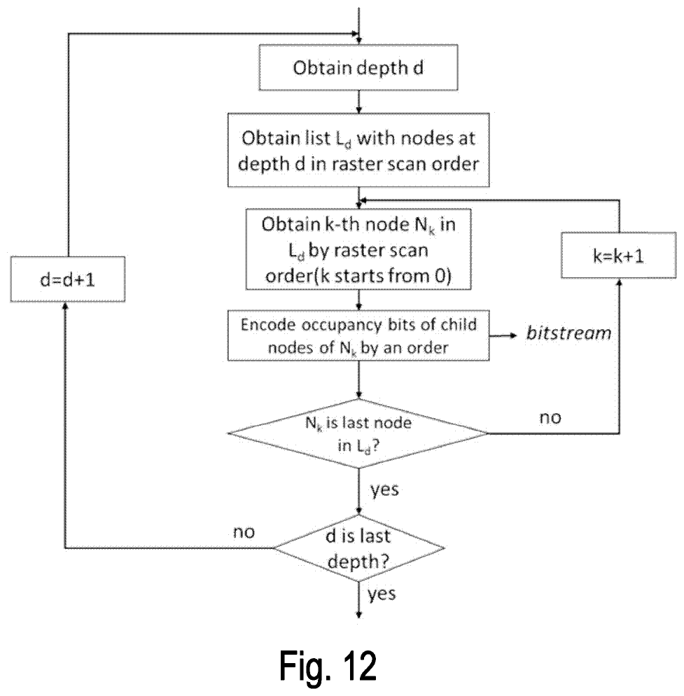

FIG. 11 shows an example of child nodes occupancy decoding process of decoder in this embodiment, and FIG. 12 shows an example of the encoder of this embodiment, and the ordering process of child nodes is not shown in both FIG. 11 and FIG. 12.

The detailed process in encoder/decoder can be described as below:
Obtain a fifo list L_{d} storing nodes at depth d by raster scan order
Obtain node Nₖ(xₖ, yₖ, zₖ) at depth d from the fifo list L_{d}, and initially at each depth it starts from the first node N₀ (x₀, y₀, z₀),
decode/encode its child nodes occupancy bits by an order, like Morton order, from/into bitstream,
if Nₖ is not last node in the fifo list L_{d}, go to encode/decode next node Nₖ₊₁(xₖ₊₁, yₖ₊₁, zₖ₊₁) in the fifo list L_{d} until it reaches the last node in L_{d}.
go to encode child nodes occupancy of next depth until it reaches the final depth.

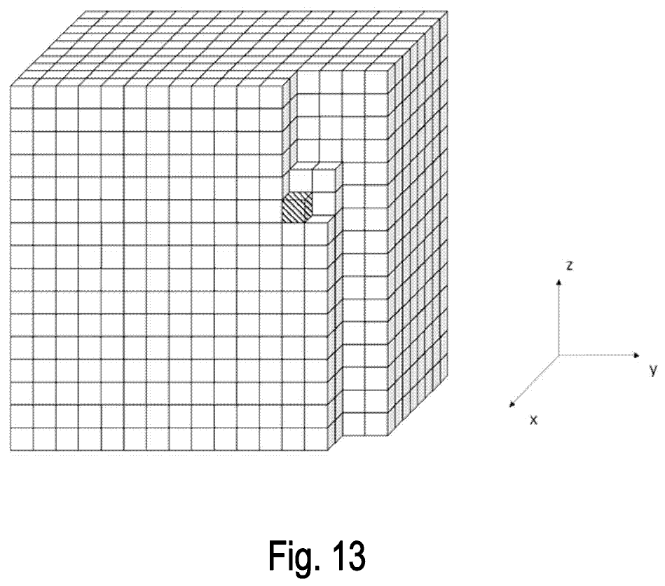

FIG. 13 shows the occupancy map of child nodes already known when coding the occupancy bit for the striped child volume when using the alter-native coding order described for FIG. 5. With the raster scan ordering of the nodes (whatever is the axis ordering used in lexicographic order), the occupancy of any child volume of a node with a lower z, a lower y or a lower x position than the current node (parent node of the striped child volume) may be used for contextualizing entropy coding of the striped child volume occupancy bit, as well as any child volume occupancy bits previously coded for the current node. With this approach, we can clearly distinguish there is one different pattern for the available neighbouring nodes for each position of the coded child volume occupancy. Thus, with octree occupancy there are 8 different patterns. The entropy coding of the occupancy bits thus needs to be tuned according to each pattern (i.e., for each occupancy bit index) in order to be more optimal.

It complexify a bit the encoding with respective to the first example, but is still more optimal than the patterns in octree with nodes coded in Morton order as that in prior art. In the prior art, with Morton ordering of the nodes, the pattern for “unknown” (i.e. not yet coded) neighbouring nodes occupancy vary much more with the positions in the ancestor nodes (and so with the Morton index), thus some neighbouring information is not always reliable when building the entropy contexts and it may introduce bias in entropy coding probabilities built in adaptive entropy coding context, thus reducing the coding performances.

It should be understood that in point cloud coding, the occupied nodes and child nodes would rarely (and preferably never) be as dense as in example in FIG. 4, FIG. 5, FIG. 9 and FIG. 10. These figures are densely represented to provide a better view of the causal child occupancy information available and of the nodes/child nodes processing order. In usual point clouds several volumes will be unoccupied, and so, no nodes for these volumes will exist and will be processed. The processing order of the occupied nodes re-main the same as if the content was dense, and for a given occupied node the occupancy of all the children volumes is always coded, but the unoccupied nodes/volumes are not processed at all because they are not present in the tree structure. In comparison to the processing order of a dense content, the processing of these unoccupied nodes/volume is just skipped.

In prior art, to construct the neighbour pattern for entropy coding of nodes, it uses occupancy atlas to store occupancy information of many nodes of a cube, for example, for example a cube of 512*512*512 nodes is used in current G-PCC method, which causes a lot of memory usage. In detail, in current G-PCC method, the octree geometry coding method uses Morton ordering of the nodes for coding information of occupancy tree. When coding occupancy bits, entropy coding contexts are usually built based on neighbouring nodes and/or neighbouring child nodes occupancy. However, with Morton ordering, obtaining neighbouring nodes or child nodes occupancy requires either to use a significant amount of memory usage (for an occupancy atlas or a hash table of occupied nodes for instance) or to use search algorithm having at best a worst-case complexity in O(N·log 2(N)).

Thus, the problem to solve by the present disclosure is how to retrieve neighbouring nodes and/or neighbouring child nodes occupancy while coding or decoding the occupancy tree without sacrificing memory for an occupancy atlas nor increasing the overall complexity with O(N·log 2(N)) search algorithm.

The proposed method is to process the nodes based on raster scan ordered nodes and only storing information of neighbour nodes adjacent to the nodes to be encoded/decoded to construct neighbour pattern used for entropy coding. Using that order a buffer of raster scan ordered nodes may be used to both process the nodes in order and search for neighboring nodes (which may also be associated with already decoded child occupancy if needed).

By doing so, the memory increase is marginal, because the buffer is already present for usual processing of the nodes, and the proposed method is to make use of the buffer to generate neighbour pattern used for entropy coding. Also, the complexity for the search of the neighbours can be expressed in O(N).

As previously mentioned, with Morton ordering of the nodes, it is difficult to avoid using an occupancy atlas to obtain neighbourhood occupancy (for contextualization of entropy coding) without sacrificing coding performances or introducing search complexity.

With raster scan ordering of the nodes, if one wants to use an occupancy atlas in order to retrieve neighbourhood occupancy, it is not as easy to restrict the atlas size to a sub-volume as with Morton order, because positioning in coding order is regularly traversing the entire point cloud volume on the two first axis while increasing in the third one. Thus, with raster scan ordering, in order to be efficiently used to provide the occupancy neighbourhood, the atlas would have to be representative of a number of previously coded slices of nodes (a slice of nodes being representative of all the nodes with a given position on third axis), the number of slices limiting the distance of the neighbourhood along third axis. Thus, if the point cloud is 2^{D}×2^{D}×2^{D} at depth D, the size of the buffer for child nodes would have to be a multiple of 2^{D+1}×2^{D+1}. Depending on the size of the point cloud, the buffer could require far more memory than what is typically used with Morton ordered nodes occupancy atlas.

Fortunately, with raster scan ordering of the nodes, it is possible to avoid wasting that much memory with an occupancy atlas. Instead of maintaining a buffer of occupancy bits for a dense volume (the atlas), it is possible to maintain a few pointers/iterators/indexes on the list of nodes each point-er/iterator/index being representative of a neighbouring node position relative to the current node.

With a naïve approach, for each node whose child occupancy is being coded, for each neighbour position to be used in the coding scheme (to select en-tropy context and/or make an occupancy prediction for instance) one would have to look for the corresponding neighbour node. This search, as with Morton order would be in O(log(N)) with N the number of nodes at the current tree depth, by doing, for instance, a dichotomic search on the raster scan ordered nodes. If the node is found the volume is occupied, and its children occupancy, which may have been associated to it when being coded/decoded, can be retrieved. If the node is not found the volume is not occupied and so its children's sub-volumes are also not occupied.

This naïve approach is yet not optimal at all. For coding the children occupancy of N nodes of a given depth the complexity would be in O(N*log(N)). And with M the number of neighbouring nodes looked for and used for the coding process on one node (prediction/contexts) the complexity can even be expressed in O(M*N*log(N)).

To exploit the advantage of raster scan ordered nodes and also to reduce the memory consumption, the proposed method retrieve the neighbour node occupancy by only storing occupancy information of neighbour nodes adjacent to current nodes to construct neighbour pattern for entropy coding.

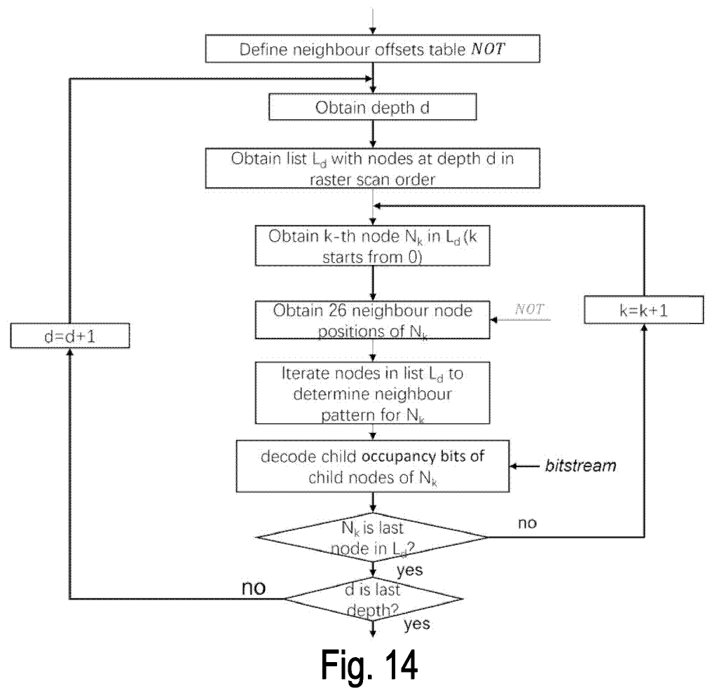

In some embodiments, the decoder is shown in FIG. 14 as a block diagram, which is based on the previously described raster scan order coding method, wherein coding the occupancy of the children nodes/volumes of all the nodes of a given depth are performed in a single pass on the nodes, following their raster scan order. Because of the raster scan order, the nodes associated to a given neighbouring position (same relative position for every node) can also be processed in a single pass on the node. For instance the index, in raster scan order, of a neighbour node at a position (−1,−1,−1) relative to the pro-cessed node, will be increasing when increasing the index in raster can order of the processed node. Thus, by keeping the index of the neighbour node at a position (−1,−1,−1) of previously processed node, this index of the processed node can be increased, based on the kept index of previously process node, until
1) finding the neighbour node at a position (−1,−1,−1) of the current processed node, in case the neighbour node is occupied and so it is in the raster scan ordered list of processed nodes, or
2) finding a node with a position that is higher in raster scan order than position (−1,−1,−1) relative to the current processed node, in case the neighbour volume at position (−1,−1,−1) relative to current processed node is not occupied.

As a reminder, considering raster scan order corresponding to a lexicographic order in (x, y, z), the condition for a position (x1, y1, z1) is higher or equal to a position (x0, y0, z0) in raster scan order is that if x1>x0, or if x1=x0 and y1>y0, or if x1=x0, y1=y0 and z1>z0.

As is shown in FIG. 14, the proposed decoding process follows the steps of:
Determine a neighbour offsets table NOT, which defines the relative coordinate between each neighbour node position and current node position, wherein each neighbour node shares a common face, common vertex or common edge with current node.
Iterate the nodes at each depth to decode occupancy tree
   Obtain a depth d, and the list L_{d} storing the nodes at depth d in raster scan order
      Iterate on each node in list L_{d}
         to determine its neighbour occupancy
         For each node Nₖ, use defined NOT and its position Pₖ to determine positions of 26 neighbour nodes NeighP,

$$NeighP [ i ] = Pk + NOT [ i ] ,$$

and 26 pointers are used to track neighbour nodes at corresponding positions, by keeping index of the neighbour node at corresponding position of previously processed node for processing next node, the neighbour node obtained with NOT[i] can be searched from the kept index in list L_{d};
A pointer is defined and used to iterate nodes in the list L_{d} to determine the occupancy information of 26 neighbour nodes (if they are occupied or not).
and then use the obtained neighbour node occupancy to construct neighbour pattern for each node, the neighbour pattern can be used for context selection in entropy coding
decode child occupancy bits of the node by entropy coding method, from a bitstream

In some embodiments, less than 26 neighbour nodes may be used, for instance to reduce complexity.

In some embodiments, neighbour nodes of a node Nₖ may be farther from if (i.e., they may not share a face, an edge or a vertex with node Nₖ), for instance to improve coding performances by using a more complex neighbour pattern.

In some embodiments, more than 26 neighbours nodes may be used, for instance to improve coding performances by using a more complex neighbour pattern.

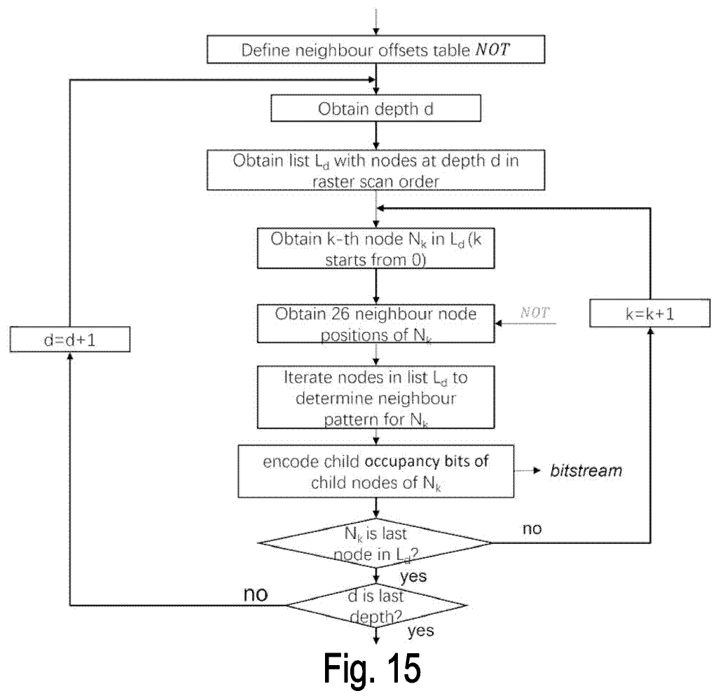

And the corresponding encoder of the embodiment is shown in FIG. 15.

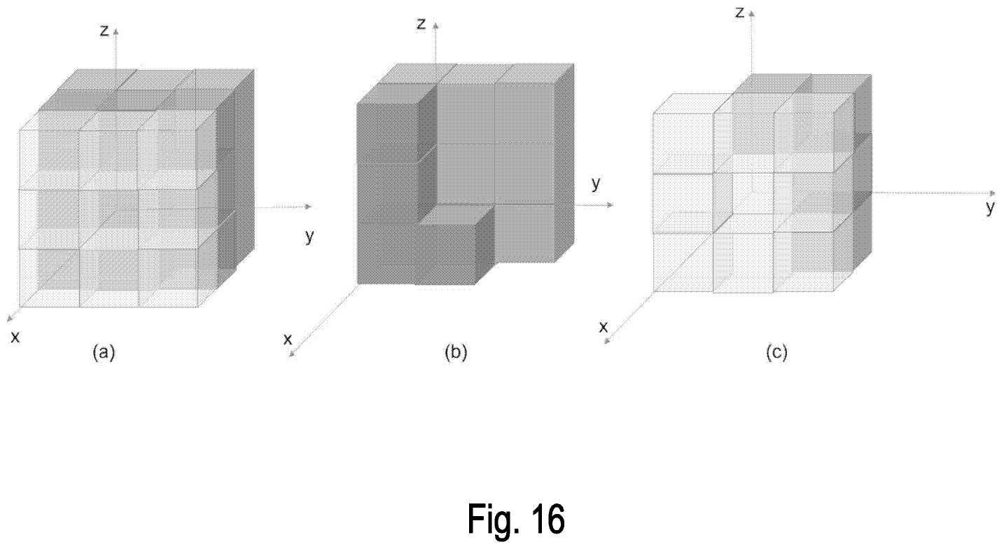

In some embodiments, there are 26 neighbour nodes to be retrieved to obtain neighbour pattern for current node being coded, which is shown in FIG. 16(a). To determine the relative position of each neighbour node relative to current node, a table NOT[i]i=0, 1, . . . , 26 indicating relative position is defined, wherein each element in the table represents a position offset between neighbour node and current node. There are totally 27 elements in the table, including one element for current node and 26 elements for neighbour nodes. And the index i of each element NOT[i] indicates the order of each neighbour node among the 26 neighbour nodes of current node in raster scan order. Each element NOT[i] has three dimensions, the first dimension represents relative position difference along x coordinate, the second dimension represents relative position difference along y coordinate, and the third dimension represents relative position difference along z coordinate. Thus, a neighbour offsets table NOT[i]i=0, 1, . . . , 26 can be defined as

$$\{ \{ - 1 , - 1 , - 1 \} , \{ - 1 , - 1 , + 0 \} , \{ - 1 , - 1 , + 1 \} , \{ - 1 , + 0 , - 1 \} , \{ - 1 , + 0 , + 0 \} , \{ - 1 + 0 , + 1 \} , \{ - 1 , + 1 , - 1 \} , \{ - 1 , + 1 , + 0 \} , \{ - 1 , + 1 , + 1 \} , \{ + 0 , - 1 , - 1 \} , \{ + 0 , - 1 , + 0 \} , \{ + 0 , - 1 , + 1 \} , \{ + 0 , + 0 , - 1 \} , \{ + 0 , + 0 , + 0 \} , \{ + 0 , + 0 , + 1 \} , \{ + 0 , + 1 , - 1 \} , \{ + 0 , + 1 , + 0 \} , \{ + 0 , + 1 , + 1 \} , \{ + 1 , - 1 , - 1 \} , \{ + 1 , - 1 , + 0 \} , \{ + 1 , - 1 , + 1 \} , \{ + 1 , + 0 , - 1 \} , \{ + 1 , + 0 , + 0 \} , \{ + 1 , + 0 , + 1 \} , \{ + 1 , + 1 , - 1 \} , \{ + 1 , + 1 , + 0 \} , \{ + 1 , + 1 , + 1 \} \} .$$

The neighbour offsets table NOT can be used at each depth, for each node to retrieve its neighbour node and then to get its neighbour pattern, which can be used in entropy coding.

In some embodiments, a table NOT[i]i=0, 1, . . . , 25 has 26 elements, including 26 elements for neighbour nodes and there is no element for current node, so the neighbour offsets table NOT[i]i=0, 1, . . . , 25 can be defined as

$$\{ \{ - 1 , - 1 , - 1 \} , \{ - 1 , - 1 , + 0 \} , \{ - 1 , - 1 , + 1 \} , \{ - 1 , + 0 , - 1 \} , \{ - 1 , + 0 , + 0 \} , \{ - 1 + 0 , + 1 \} , \{ - 1 , + 1 , - 1 \} , \{ - 1 , + 1 , + 0 \} , \{ - 1 , + 1 , + 1 \} , \{ + 0 , - 1 , - 1 \} , \{ + 0 , - 1 , + 0 \} , \{ + 0 , - 1 , + 1 \} , \{ + 0 , + 0 , - 1 \} , \{ + 0 , + 0 , + 1 \} , \{ + 0 , + 1 , - 1 \} , \{ + 0 , + 1 , + 0 \} , \{ + 0 , + 1 , + 1 \} \{ + 1 , - 1 , - 1 \} , \{ + 1 , - 1 , + 0 \} , \{ + 1 , - 1 , + 1 \} , \{ + 1 , + 0 , - 1 \} , \{ + 1 , + 0 , + 0 \} , \{ + 1 , + 0 , + 1 \} , \{ + 1 , + 1 , - 1 \} , \{ + 1 , + 1 , + 0 \} , \{ + 1 , + 1 , + 1 \} \} .$$

For each node, using the determined offsets table NOT, the 26 neighbour nodes at the same depth with current node can be retrieved to determine their occupancy. As is shown in FIG. 16(a), the node in the centre is the node whose child occupancy bits are being coded, and since the nodes are coded in raster scan order, in FIG. 16(b), the nodes are already encoded/decoded nodes if they are occupied (and so if the node exists in the list L_{d}). So, the child occupancy of the nodes/volumes in FIG. 16(b) is already known: if the node exits it is defined by the encoded/decoded child occupancy bits, and if the node does not exist there is no occupied child. In FIG. 16(c), the nodes are not encoded/decoded yet, so the corresponding child occupancy bits are not coded yet and so are not known yet. But if the node exists it means at least one child will be occupied, and if the node does not exist it means there is no occupied child. This is because node occupancy bit (the flag indicating if the node is occupied or not) is already known for each node/volume at current depth, because it is obtained from child occupancy bits encoding/decoding of nodes at previous one depth. The node occupancy (1 bit) of neighbour nodes shown in FIG. 16(c) can thus be determined from the presence or absence of the corresponding node in the list L_{d}.

Thus, the neighbour node occupancy includes two parts:
1. one part is composed of child occupancy of already coded nodes, and their positions are retrieved by using element in table NOT from i=0 to i=12. In some embodiments, the neighbour node occupancy is implemented as a table childOccupancy[i], i=0, 1, . . . , 12, wherein each element in table childOccupancy is composed of 8 bits for child occupancy, if the corresponding neighbour node exist and so is occupied, which is set as 0 for initialization and when node does not exist.
2. The other part is composed of node occupancy of 13 neighbour nodes that are not coded yet, and their positions are retrieved by using element in table NOT from i=14 to i=26 (i.e., i=13 might indicate the current node). In some embodiments, the neighbour node occupancy is implemented as a table depthOccupancy [i], i=14, 1, . . . , 26, wherein each element in table depthOccupancy is composed of a flag (1 bit) indicating if the corresponding neighbour node is occupied (i.e. the node exists) or not (the node does not exist), which is set as 0 for initialization.

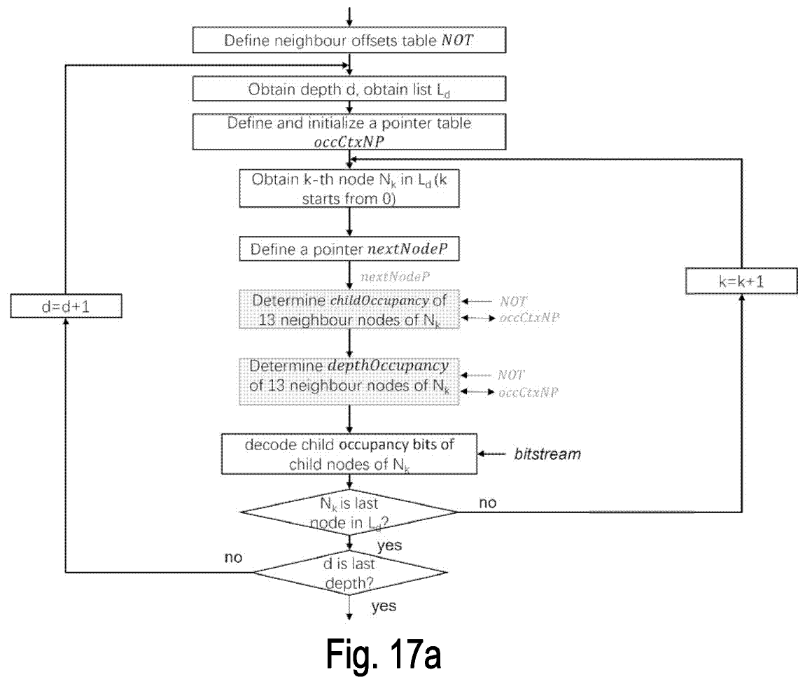

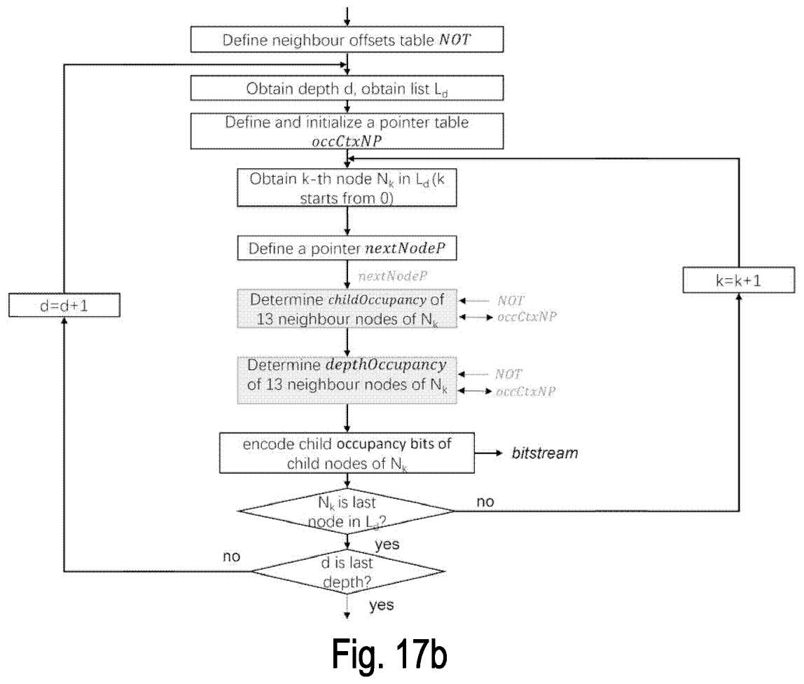

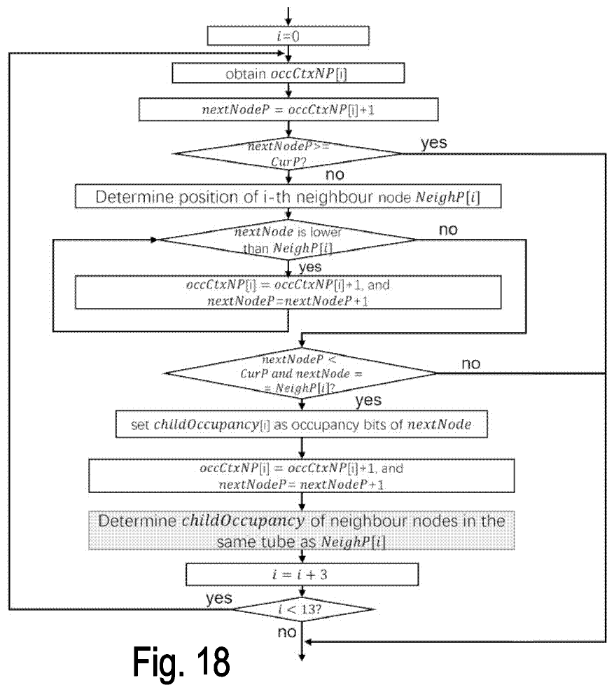

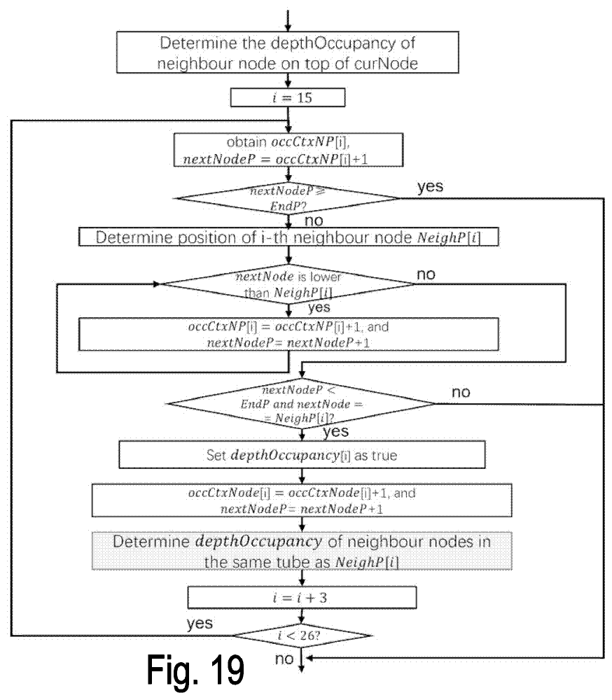

In some embodiments, the detailed process to determine occupancy of neighbour nodes for a node at each depth is shown in FIGS. 17a and 17b, FIG. 18 and FIG. 19. FIGS. 17a and 17b show the flowchart of this process, and FIG. 18 depicts the detail process to determine childOccupancy of 13 neighbour nodes of a node, and FIG. 19 depicts the detail process to determine depthOccupancy of 13 neighbour nodes of a node.

As is shown in FIGS. 17a and 17b, the proposed determination of neighbour node occupancy for a node follows the steps:
Obtain a depth d and a list L_{d} storing nodes in raster scan order
For each depth, define a pointer table occCtxNP[i], i=0, 1, . . . , 26, wherein each element in the table is a pointer for a neighbour node of current processed node, which points to address of a node in the list L_{d}.
   The table is used to track nodes neighbouring to processed node, and it is updated after searching neighbour nodes for current processed node, and the tracked neighbouring nodes for node Nₖ are obtained by updating the tracking table representative of the tracked neighbouring nodes for node Nₖ₋₁. At the start of depth d, the tracking table is initialized to be the address of first node in list L_{d}. In a variant each element of the table occCtxNP[i], i=0, 1, . . . , 26, in an index for a neighbour node of current processed node, which corresponds to the index of a node in the list L_{d}.
Obtain k-th node Nₖ from the list L_{d} according to raster scan order (for each depth k starts from 0), and encode node Nₖ at a depth d.
To encode node Nₖ at a depth d,
   define a pointer nextNodeP, which is used to iterate each node in list L_{d} for each neighbour node position to find if there is node in list L_{d} belonging to this position.
   determine the first part of neighbour node occupancy childOccupancy for the node Nₖ by using the pointer nextNodeP, the pointer table occCtxNP and the determined neighbour offsets table NOT, following the steps shown in FIG. 18, and the detail process is described in section (a) below.
   Determine the second part of neighbour node occupancy depthOccupancy for the node Nₖ by using the pointer nextNodeP, the pointer table occCtxNP and the determined neighbour offsets table NOT, following the steps shown in FIG. 19, the detail process is described in section (b) below.
After obtaining the occupancy of 26 neighbour nodes, use them to construct neighbour pattern for the node Nₖ, which is used for context selection in entropy coding of the node Nₖ.

(a). A detailed process to determine childOccupancy of 13 neighbour nodes of node Nₖ is shown below:
It iterates each neighbour node position in FIG. 16(b) based on defined neighbour offsets table NOT with i increasing from 0 to 12. To be detail,
   i start from 0, and pointer nextNodeP is defined as

$$nextNodeP = occCtxNP [ i ] + 1 ,$$

which points to next node's address of occCtxNP[i] in the list L_{d}, and occCtxNP[i] kept the index of neighbour node at corresponding position of previously processed node, so nextNodeP can search index of neighbour node for current processed node based on prior neighbour information of previously processed node at current depth.
If address of nextNodeP is not lower than current node in list L_{d}, it means that the node pointed by pointer nextNodeP is not coded yet, so cannot provide the child occupancy as neighbour occupancy for current node, then break the iteration and go to step of determining depthOccupancy; otherwise determine the neighbour position NeighP[i] based on position of current node and NOT[i] by the equation below

$$NeighP [ i ] = CurP + NOT [ i ] ,$$

wherein CurP is the position of current node.
   With position of expected neighbour node position NeighP[i],
      In a loop, increase pointer occCtxNP[i] and nextNodeP by 1 iteratively until address of node pointed by nextNodeP is larger than current node or the position of node pointed by nextNodeP is not lower than the expected neighbour node position NeighP[i].
   If address of node pointed by nextNodeP is lower than current node in list L_{d} and also the position of node pointed by nextNodeP is equal to the expected neighbour node position NeighP[i], (it means that node pointed by nextNodeP in list L_{d} belonging to neighbour node position NeighP[i] of current node, the corresponding neighbour node of current node is occupied),
      Then the i-th element of the neighbour occupancy childOccupancy[i] is determined as the 8 bits child occupancy of node pointed by nextNodeP.
      And then determine childOccupancy of two neighbour nodes in the same tube as Neigh[i], they are on top of node position NeighP[i]. In the preferred embodiment, it increases the third coordinate of NeighP[i] and also increases pointer nextNodeP, to determine the occupancy of the two neighbour nodes on top of neighbour node position NeighP[i], which will be described in detail thereafter.

(b). Detail process to determine depthOccupancy of 13 neighbour nodes of node Nₖ is described below:
Firstly, to determine the occupancy of the node on top of current node, which is depthOccupancy[0], it increases pointer nextNodeP by 1, and judge if node pointed by nextNodeP is not the last node in list L_{d} or not.
   if node pointed by nextNodeP is not the last node in list L_{d}, increase the third coordinate of current node by 1, and if the position of node pointed by nextNodeP and position of the neighbour node on top of current node are the same, (it means that the neighbour node on top of current node is occupied and node is stored in list L_{d}), then set the neighbour node occupancy depthOccupancy[0] as true.
secondly, iterate each neighbour node position in FIG. 16(c) based on defined neighbour offsets table NOT with i increasing from 15 to 26, to determine the flag of other neighbour nodes for depthOccupancy.
1. i starts from 15, and a pointer nextNodeP is defined as

$$nextNodeP = occCtxNP [ i ] + 1 ,$$

which points to next node's address of occCtxNP[i] in the list L_{d}.
   If address of nextNodeP is not the last node in list L_{d}, determine the neighbour position NeighP[i] based on position of current node and table NOT[i] by the equation below

$$NeighP [ i ] = CurP + NOT [ i ] .$$

with position of expected neighbour node position NeighP[i],
   In a loop, increase pointer occCtxNP[i] and nextNodeP by 1 iteratively until address of node pointed by nextNodeP is not smaller than the last node in list L_{d} or the position of node pointed by nextNodeP is not lower than the expected neighbour node position NeighP[i].
If address of node pointed by nextNodeP is lower than the last node in list L_{d} and also the position of node pointed by nextNodeP is equal to the expected neighbour node position NeighP[i], (it means that node pointed by nextNodeP in list L_{d} belonging to neighbour node position NeighP[i] of current node, the corresponding neighbour node of current node is occupied),
then the i-th element of the neighbour occupancy depthccupancy[i−14] is determined as true.
And then determine depthOccupancy of two neighbour nodes in the same tube as Neigh[i]. In the preferred embodiment, it increases the third coordinate of NeighP[i] and also increases pointer nextNodeP, to determine the occupancy of the two neighbour nodes on top of neighbour node position NeighP[i], which will be described in detail thereafter.

(c). Proposed neighbour node search method in list L_{d} is described below:

If the pointers occCtxNP[i] and nextNodeP are used to search for each node of the 26 neighbour nodes, then after having processed all the nodes of a given depth the neighbour node search will have iterated at most once on all nodes of the same depth. Thus, the overall complexity for finding the neighbour can be expressed in O(N) for coding the children occupancy of N nodes of a given depth. By doing the search on M neighbours, the complexity can be expressed in O(M*N).

To reduce the complexity a bit further, it is proposed to group the neighbouring node search by vertical tubes of neighbours: each successive positions in a tube would correspond to a node index increased by zero or one in the raster scan ordered list of nodes (depending on the occupancy of the corresponding volume and so the presence or not of the node in the list of processed nodes). There is only to search for first neighbour in a tube. As described above, pointers occCtxNP[i] and nextNodeP are used to only search (within the list Ld) for first neighbour in a tube of a cube of 26 neighbour nodes, so in each loop in FIG. 18 and FIG. 19 it increasing index i by 3 and the expected neighbour node position NeighP[i] in each loop is the bottom node in a tube, which will be described in detail thereafter.

By using such simple neighbouring search approach, the complexity added by the neighbour search is really negligible, and only limited additional memory is needed to store the previous location of each needed neighbouring relative position or even only previous position of the first neighbour in each tube of neighbours.

Determine childOccupancy of two neighbour nodes in the same tube as NeighP[i]:

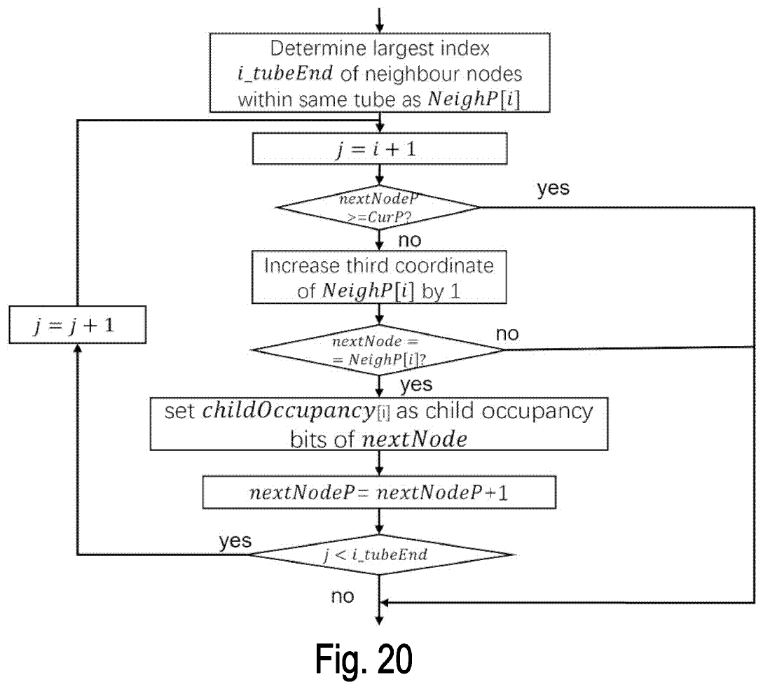

After obtaining the occupancy of the bottom neighbour node of a tube locating at NeighP[i], next is to determine the childOccupancy of two neighbour nodes on top of node positioning NeighP[i], which are in the same tube as NeighP[i], wherein the tube is of the cube of 26 neighbour nodes of current processed node. The detail process is shown in FIG. 20, and can be described as:
Firstly, determine the largest index i_tubeEnd of neighbour node within same tube as NeighP[i], i_tubeEnd is defined as

$$i\_tubeEnd = \{ \begin{matrix}i + 3 , if i + 3 < N\_size \\ N\_size , if i + 3 \geq N\_size\end{matrix}$$

Define an index j, and j=i+1. Then iterate each neighbour position on top of the bottom node of a tube until j reach i_tubeEnd.
   At each iteration, firstly judge if node pointed by pointer nextNodeP is not larger than address (CurP) of current node in list L_{d}, increase the third coordinate of NeighP[i] by 1 to look the neighbour node on top of NeighP[i].
      If the position of node pointed by pointer nextNodeP is the same as the increased position NeighP[i], then set the corresponding neighbour node occupancy childoccupancy[i] as child occupancy bits of the node pointed by pointer nextNodeP. And also let the pointer point to next node in list L_{d} (let address of node pointed by pointer nextNodeP increase by 1).

Determine depthOccupancy of two neighbour nodes in the same tube as NeighP[i]:

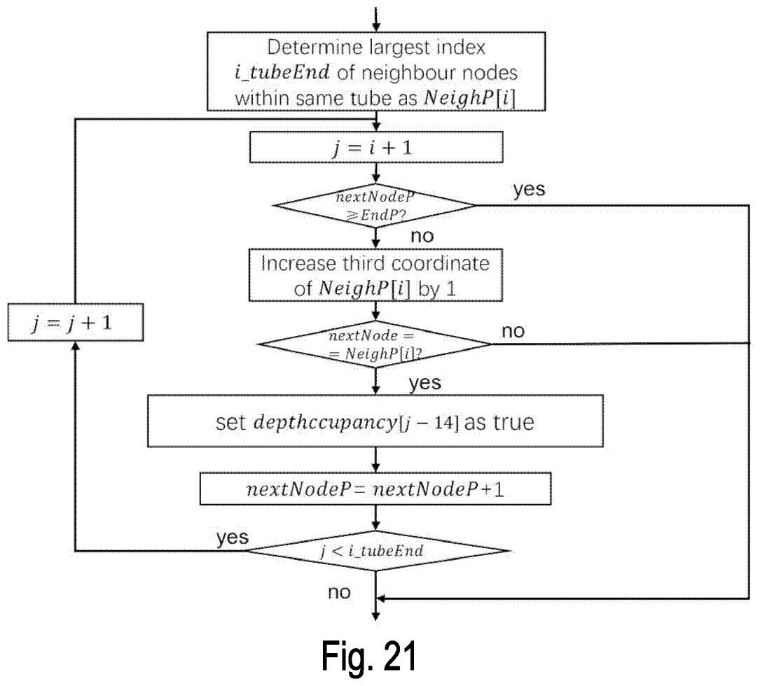

After obtaining the occupancy of the bottom neighbour node of a tube locating at NeighP[i], next is to determine the depthOccupancy of two neighbour nodes on top of node positioning NeighP[i], which are in the same tube as NeighP[i], wherein the tube is of the cube of 26 neighbour nodes of current processed node. The detail process is shown in FIG. 21, and can be described as:
Firstly, determine the largest index i_tubeEnd of neighbour node within same tube as NeighP[i], i_tubeEnd is defined as

$$i\_tubeEnd = \{ \begin{matrix}i + 3 , if i + 3 < N\_size \\ N\_size , if i + 3 \geq N\_size\end{matrix}$$

Define an index j, and j=i+1. Then iterate each neighbour position on top of the bottom node of a tube until j reaches i_tubeEnd.
   At each iteration, firstly judge if node pointed by pointer nextNodeP is not last node of list L_{d}, increase the third coordinate of NeighP[i] by 1 to look the neighbour node on top of NeighP[i].
      If the position of node pointed by pointer nextNodeP is the same as the increased position NeighP[i], then set the corresponding neighbour node occupancy depthccupancy[j−14] as true. And also let the pointer point to next node in list L_{d} (let address of node pointed by pointer nextNodeP increase by 1).

In case a full raster scan ordering for the coding of child nodes occupancy is used, as in the first example of the previously described method (example 1), it encodes the child nodes in raster scan order at each depth, so the neighbour information used to entropy code each child is based on neighbour child node of current child node to be coded.

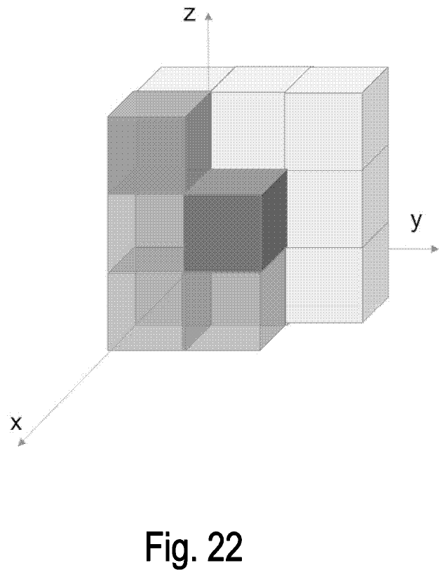

Since the child nodes of all occupied nodes at depth d are coded in raster scan order, so the neighbour child nodes that are lower than current child node in raster scan order are already coded and their 1 bit occupancy is already known, and the neighbour child nodes that are higher than current child node are not coded yet and their 1 bit occupancy is not known yet. Thus, only the neighbour child nodes that are lower than current child node are retrieved for neighbour searching, so there are 13 neighbour child nodes to be retrieved, which is shown in FIG. 22, wherein each cube represents child node and the green cube represents current child node to be coded. And each neighbour child node has a relative position to current child node, so the corresponding neighbour child node position offsets table CNOT[i], i=0, 1, . . . , 12 is

$$\{ \{ - 1 , - 1 , - 1 \} , \{ - 1 , - 1 , + 0 \} , \{ - 1 , - 1 , + 1 \} , \{ - 1 , + 0 , - 1 \} , \{ - 1 , + 0 , + 0 \} , \{ - 1 , + 0 , + 1 \} , \{ - 1 , + 1 , - 1 \} , \{ - 1 , + 1 , + 0 \} , \{ - 1 , + 1 , + 1 \} , \{ + 0 , - 1 , - 1 \} , \{ + 0 , - 1 , + 0 \} , \{ + 0 , - 1 , + 1 \} , \{ + 0 , + 0 , - 1 \} \} ,$$

and index i is based on the raster scan order of the neighbour child nodes.

### Child Neighbour Node Occupancy Determination Method:

To obtain the child neighbour occupancy of current node:
Define a pointer table occCtxNodes of 13 dimensions for 13 neighbour child nodes of current child node, which points to address of nodes in list L_{d}. Here the list L_{d} storing child nodes of all occupied nodes at depth d in raster scan order. And the table occCtxNodes is initialized to be address of the first child node in list L_{d} for each depth.
Define a pointer nextNodeP to point to the next node of one neighbour child node in list L_{d}, and it can be obtained by

$$nextNodeP = occCtxNodes [ i ] + 1$$

Determine the occupancy consisted of 1 bit occupancy of 13 child neighbour nodes by searching child nodes in list L_{d} for each neighbour child position.
   For a child neighbour node position NeighCP[i], which is the bottom child node of a tube, can be obtained by

$$NeighCP [ i ] = CurCNode + CNOT [ i ] ,$$

use pointers nextNodeP and occCtxNodes[i] to iterate child nodes in list L_{d} to obtain occupancy of node locating at NeighCP[i]. The detail process is same as that in the preferred embodiment of the proposed method.
For the two child neighbour nodes on top of node locating at NeighCP[i], since the neighbour child nodes are stored in raster scan order, just increase the third coordinate of NeighCP[i] by one or by two and also the nextNodeP by one or by two, to obtain their occupancy bit. The detail process is the same as that in the preferred embodiment of the proposed method.

In some embodiments (e.g., FIGS. 5-8), to encode/decode the 8 bits child occupancy of each node at a depth, the coding of each node is achieved by processing the node 4 times, and it performs a search for neighbouring nodes each time a node is being processed (i.e., for each tube of children), so the complexity is roughly increased by a factor up to 4.

To process efficiently each tube of nodes, rather than using O(log(N)) searches to look for the first node of the tube (or slice) and their neighbours, each time a new tube (or slice) is started, they can be kept in memory the first time they are encountered. Two local copies of a node index and its neigh-bours' indexes are enough to keep the overall linear complexity.
A first copy is reset with position of a node and its neighbours each time the node is the first processed in the processing of a slice 0. This copy is used to reinitialize the search for nodes and their neighbours when the processing of slice 1 is being started.
The second copy is reset with position of a node and its neighbours each time the node is the first processed in the processing of a tube 0 or a tube 2. This copy is used to reinitialize search for nodes and their neighbours when the processing of a tube 1 or tube 3 is being started.

In some embodiments, for child raster scan coding order, the pointer for parent nodes are restored at beginning of the tube/slice each time we iterate on a tube [1 or 3]/slice [1] of children (neighbour pattern must be saved when starting a tube of (parent) nodes [i.e. tube 0 and tube 2 of children] and when starting a slice of (parent) nodes [i.e. slice 0]).

When iterating in the list of nodes, the end of a tube of nodes or the end of a slice of node can be detected by comparing next node position to the current node position: if at least one of the first (x) and second coordinates (y) (in used lexicographic order) is different, it indicates the end of a tube; if at least the first coordinate is different, it indicates the end of a slice (x).

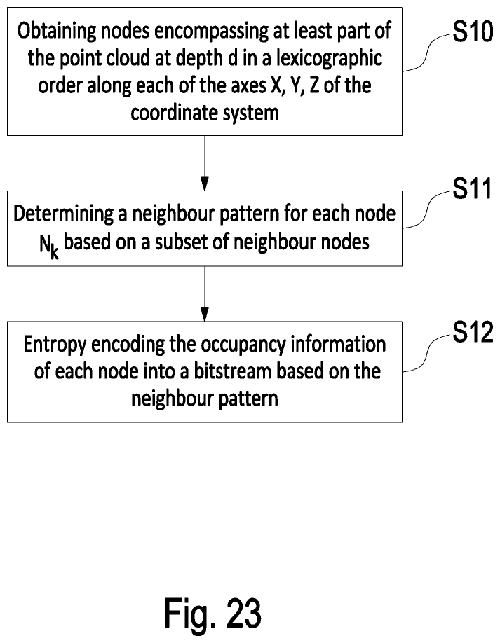

Reference is now made to FIG. 23 showing a schematic flow diagram of the method for encoding a 3D point cloud into a bitstream according to the pre-sent disclosure.

The method includes:

In step S10, nodes encompassing at least part of the point cloud at depth d in a lexicographic order along each of the axes X, Y, Z of the coordinate system is obtained;

In step S11, a neighbour pattern for each node Nₖ based on a subset of neighbour nodes is determined.

In step S12, the occupancy information of each node is entropy encoded into a bitstream based on the neighbour pattern

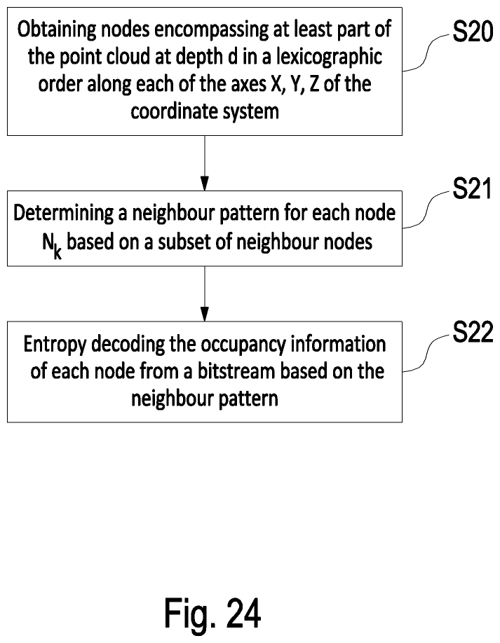

Reference is now made to FIG. 24 showing a schematic flow diagram of the method for decoding a 3D point cloud from a bitstream according to the present disclosure.

The method includes:

In step S20, nodes encompassing at least part of the point cloud at depth d in a lexicographic order along each of the axes X, Y, Z of the coordinate system are obtained;

In step S21, neighbour pattern for each node Nₖ based on a subset of neighbour nodes is determined.

In step S22, the occupancy information of each node is entropy decoded from a bitstream based on the neighbour pattern.

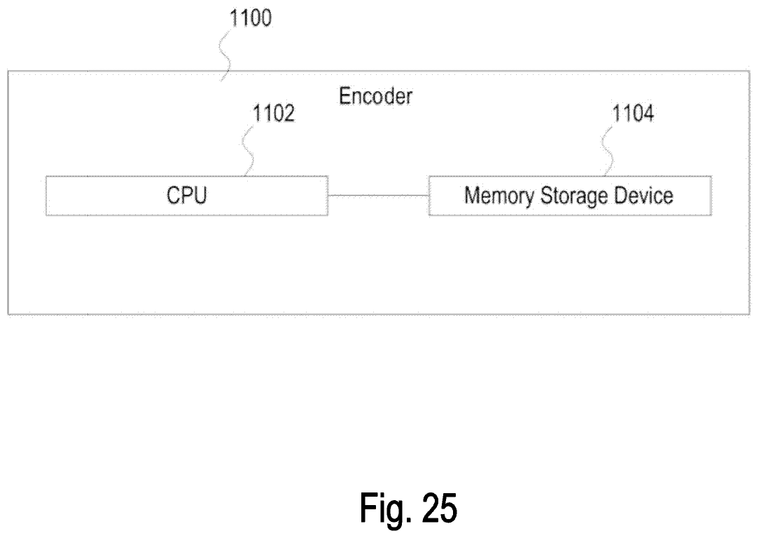

Reference is now made to FIG. 25, which shows a simplified block diagram of an example embodiment of an encoder 1100. The encoder 1100 includes a processor 1102 and a memory storage device 1104. The memory storage device 1104 may store a computer program or application containing instructions that, when executed, cause the processor 1102 to perform operations such as those described herein. For example, the instructions may encode and output bitstreams encoded in accordance with the methods de-scribed herein. It will be understood that the instructions may be stored on a non-transitory computer-readable medium, such as a compact disc, flash memory device, random access memory, hard drive, etc. When the instructions are executed, the processor 1102 carries out the operations and functions specified in the instructions so as to operate as a special-purpose processor that implements the described process(es). Such a processor may be referred to as a “processor circuit” or “processor circuitry” in some examples.

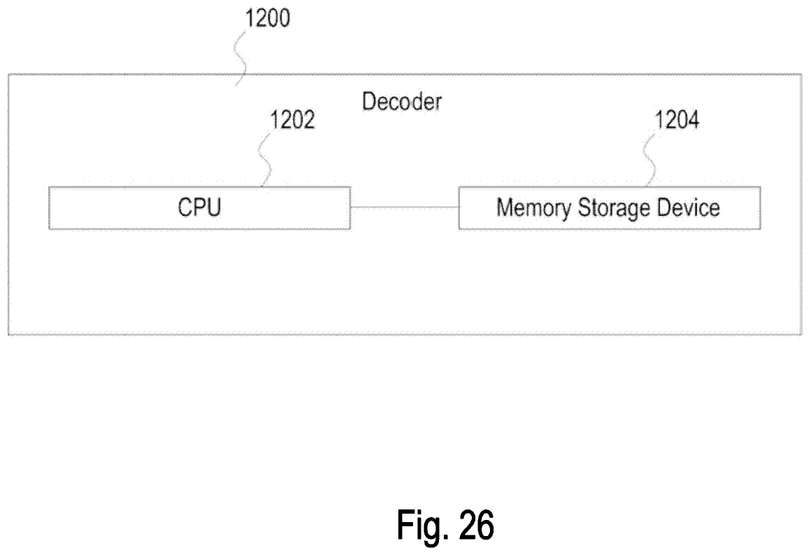

Reference is now also made to FIG. 26, which shows a simplified block diagram of an example embodiment of a decoder 1200. The decoder 1200 includes a processor 1202 and a memory storage device 1204. The memory storage device 1204 may include a computer program or application containing instructions that, when executed, cause the processor 1202 to per-form operations such as those described herein. It will be understood that the instructions may be stored on a computer-readable medium, such as a com-pact disc, flash memory device, random access memory, hard drive, etc. When the instructions are executed, the processor 1202 carries out the operations and functions specified in the instructions so as to operate as a special-purpose processor that implements the described process(es) and methods. Such a processor may be referred to as a “processor circuit” or “processor circuitry” in some examples.

It will be appreciated that the decoder and/or encoder according to the pre-sent application may be implemented in a number of computing devices, including, without limitation, servers, suitably programmed general purpose computers, machine vision systems, and mobile devices. The decoder or encoder may be implemented by way of software containing instructions for configuring a processor or processors to carry out the functions described herein. The software instructions may be stored on any suitable non-transitory computer-readable memory, including CDs, RAM, ROM, Flash memory, etc.

It will be understood that the decoder and/or encoder described herein and the module, routine, process, thread, or other software component implementing the described method/process for configuring the encoder or decoder may be realized using standard computer programming techniques and languages. The present application is not limited to particular processors, computer languages, computer programming conventions, data structures, other such implementation details. Those skilled in the art will recognize that the described processes may be implemented as a part of computer-executable code stored in volatile or non-volatile memory, as part of an application-specific integrated chip (ASIC), etc.

The present application also provides for a computer-readable signal encoding the data produced through application of an encoding process in accordance with the present application.

Certain adaptations and modifications of the described embodiments can be made. Therefore, the above discussed embodiments are considered to be illustrative and not restrictive. In particular, embodiments can be freely combined with each other.

1. A method for encoding a 3D point cloud into a bitstream, implemented in an encoder, a geometry of the point cloud being defined in an octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein occupancy information associated with each respective child sub-volume indicates whether that respective child sub-volume contains at least one of the points, the method comprising:
obtaining nodes encompassing at least part of the point cloud at a depth d in a lexicographic order along each of axes X, Y, Z of the coordinate system;
determining a neighbour pattern for each node Nₖ based on a subset of neighbour nodes; and
entropy encoding the occupancy information of each node into a bitstream based on the neighbour pattern.

2. A method for decoding a 3D point cloud from a bitstream, implemented in a decoder, a geometry of the point cloud being defined in an octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein occupancy information associated with each respective child sub-volume indicates whether that respective child sub-volume contains at least one of the points, the method comprising:
obtaining nodes encompassing at least part of the point cloud at a depth d in a lexicographic order along each of axes X, Y, Z of the coordinate system;
determining neighbour pattern for each node Nₖ based on a subset of neighbour nodes; and
entropy decoding the occupancy information of each node from a bitstream based on the neighbour pattern.

3. The method according to claim 1, further comprising:
storing occupied child nodes at a depth d+1 in a lexicographic order.

4. The method according to claim 1, wherein at least one of the lexicographic order of nodes at depth d or the lexicographic order of child nodes at depth d+1 is a raster scan order.

5. The method according to claim 1, wherein the entropy encoding of the occupancy information of the child nodes of each node into the bitstream is based on the lexicographic order of nodes at the depth d and a fixed order of the child nodes for a given node.

6. The method according to claim 3, wherein storing the occupied child nodes at the depth d+1 is performed by processing each node in a single pass on all the nodes of obtained nodes, or by using intermediate storage to order child nodes in the lexicographic order or in raster scan order.

7. The method according to claim 1, wherein the subset of neighbour nodes for Nₖ is kept using a tracking table, wherein the tracking table limits the number of neighbour nodes to be kept, wherein the tracking table is obtained by updating the corresponding tracking table for node Nₖ₋₁.

8. The method according to claim 7, wherein the tracking table is a first neighbour offset table, wherein the first neighbour offset table stores the relative position of the neighbour nodes with respect to the current node Nₖ.

9. The method according to claim 1, wherein the obtained nodes at the depth d are stored in a first linked data structure and the subset of neighbour nodes are obtained by iterating on the nodes in the first linked data structure, wherein the first linked data structure has elements connected to each other so that elements are arranged in a sequential manner.

10. The method according to claim 7, wherein the tracking table is updated by grouping the subset of neighbour nodes search by using vertical tubes of neighbours, wherein each vertical tube comprises nodes sharing the same coordinate on two axes of the coordinate system.

11. The method according to claim 1, wherein the neighbour pattern is a binary word indicating neighbouring occupancy, the binary word is obtained based on a first and a second occupancy of neighbour nodes, wherein the first occupancy of neighbour nodes has a lower coordinate value than a current node on at least one axis, wherein each of the first occupancy of neighbour nodes comprises 8 bits child occupancy, and the second occupancy of neighbour nodes has a higher coordinate value than the current node on at least one axis, wherein each of the second occupancy of neighbour nodes comprises a flag indicating the corresponding neighbour node occupancy.

12. The method according to claim 1, wherein child nodes of all occupied nodes are encoded in raster scan order of child nodes.

13. The method according to claim 12, wherein the child nodes are stored in a second linked data structure and a subset of neighbour child nodes for given neighbour child node positions of a current child node CNₖ are obtained by iterating on the child nodes in the second linked data structure, wherein the second linked data structure having elements connected to each other so that elements are arranged in a sequential manner.

14. The method according to claim 13, wherein the subset of neighbour child nodes is kept using a second neighbour offset table, wherein the second neighbour offset table stores the relative position of the neighbour child nodes with respect to the current child node.

15. The method according to claim 13, wherein an occupancy of neighbour child nodes having a lower coordinate value than a current child node in the second linked data structure is a flag indicating the corresponding occupancy of neighbour child node.

16. The method according to claim 15, wherein the subset of neighbour child nodes is representative of tracked neighbour child node in the second linked data structure for the current child node, and is updated for neighbour child node searching of next child node.

17. An encoder to encode a 3D point cloud into a bitstream, comprising:
at least one processor; and
a memory storing instructions executable by the processor;
wherein the processor is configured to perform the method according to claim 1.

18. A decoder to decode a 3D point cloud from a bitstream, comprising:
at least one processor; and
a memory storing instructions executable by the processor;
wherein the processor is configured to perform the method according to claim 2.

19. (canceled)

20. A non-transitory computer-readable storage medium storing instructions that, when executed by a processor, cause the processor to perform the method according to claim 1.
